(19) United States
(12) Patent Application Publication
(10) Pub. No.: US 2016/0171405 A1
(43) Pub. Date: Jun. 16, 2016

(54) User Interactive On-Site Job Management System and Uses Thereof

(71) Applicant: Brian Keith Burke, Huffman, TX (US)

(72) Inventor: Brian Keith Burke, Huffman, TX (US)

(21) Appl. No.: 14/571,508

(22) Filed: Dec. 16, 2014

(51) Int. Cl. G06Q 10/06; G06Q 30/06; G06F 17/30; G06Q 40/00; G06F 3/0482; G06F 3/0484

(52) U.S. Cl. CPC G06Q 10/06313; G06F 3/0482; G06F 3/04842; G06F 17/30864; G06Q 10/063114; G06Q 40/125; G06Q 30/0611

(57) ABSTRACT

Provided herein are systems and methods for on-site job management used for monitoring and optimizing the efficiencies of a project. The system comprises a job bid management system, an electronic mobile device having at least a processor, a memory and a display coupled to the processor and at least one network connection, an equipment monitoring system, an interactive mobile tool for on-site job optimization coupled to the electronic device, an enterprise resource planning system; a project planning system; an external weather service, a document imaging system and a server machine having at least a processor, a memory and a display coupled to the processor, and an interactive server tool interfaced with all the components described above for on-site job optimization.

### BACKGROUND OF THE INVENTION

1. Field of the Invention

The present invention relates generally to the field of mobile or computer applications for on-site project or job management. More specifically, the present invention relates to an application and system thereof for integrating job bidding and pre-construction processes, with field-level job execution processes of projects for a company using a mobile smart device coupled with a server computer.

2. Description of the Related Art

Implementing suitable project management strategies can significantly help organizations create an edge over the competitors. The ability to deliver projects and/or jobs on time and within budget often determines whether a company will get the next job. Many companies, especially the leading organizations across sectors, have realized project management as a way to efficiently control spending and improve project results. Increasingly, organizations are willing to invest time, money and resources to build organizational project management expertise to lower the costs, increase the efficiencies and keep a greater competitive advantage.

To maximize the efficiency of project management, especially for projects which include a great number of sub-tasks and resource distributions, a few software companies have developed applications to allow companies to implement project management strategies via the computer. Project® from Microsoft® has dominated the market of project management software for the last decade. However, this application merely functions as a planning tool, providing overall information such as work breakdown structure. It does not integrate detailed on-field and/or on-site task management strategies. More specifically, Project® of Microsoft® merely operates on a spreadsheet-based planner level. There is no module in the software designed to monitor and control the progress of the projects in terms of labor hour management, equipment hour management, or material management. Moreover, this software lacks modules that enable direct interaction between the user or foreman on the job site and the software. Also, it does not include any automated features such as geo-fence of the project, locations of sites, or automatic data synchronization.

Thus, there is a recognized need, for a computer- and/or mobile-based on-site job management system that integrates interactive and automated features, focuses on detailed real-time on-site resource monitoring and allocation and project progress, and provides constantly updated on-site information to all the users. Particularly, the prior art is deficient in these aspects. The present invention fulfills this longstanding need and desire in the art.

### SUMMARY OF THE INVENTION

The present invention is directed to a system for optimizing the on-site job execution and management for a team or an organization. The system comprises a job bid management system; an electronic mobile device having at least a processor, a memory and a display coupled to the processor; at least one network connection; an equipment monitoring system; an interactive mobile tool for on-site job optimization coupled to the electronic device; an enterprise resource planning system; a server machine having at least a processor, a memory and a display coupled to the processor; a project planning system; an external weather module interfaced with the interactive mobile tool; a document imaging system; an interactive server tool for on-site job optimization coupled to the server and communicably connected to the bid management system, the equipment monitoring system, the interactive on-site job optimization mobile tool, the enterprise resource planning system, said project planning system, said document imaging system and via the network connection.

The present invention also is directed to a user-implemented method for optimizing on-site job execution and management for an assigned project. The method comprises loading the initial data and information related to one or more jobs to the interactive server tool described supra and setting up the security limits and access rights for the interactive mobile tools via the interactive server tool. All the data and information related to one or more jobs is synchronized to one or more authorized interactive mobile tools as described herein. Field employees are clocked in and out of a job throughout the day using the interactive mobile tool and the time clock transactions are submitted to the interactive server tool. The equipment information on the job is monitored via the equipment monitoring system throughout the day and all the updated data and information related to the one or more jobs from previous day is synchronized. The progress for the previous day is entered via the interface of the interactive mobile tool and labor hours and equipment hours are allocated to tasks. Material usage is entered, a daily report including any outstanding issues is submitted and the updated data is transmitted to the interactive server tool from the interactive mobile tool. Field purchase orders for needed material or subcontractors are created and transmitted to the interactive server tool. Import files for the enterprise resource planning system and payroll system are generated.

Other and further aspects, features, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be had by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIGS. 1A-1E are the overall flowcharts for optimizing on-field job execution for each assigned project using the system for optimizing the execution of one or more projects assigned to a team or organization. FIG. 1A depicts the main components of the on-site job optimizing system and the types of information/data transmitted among these components. FIG. 1B-1E depicts the overall process of managing and optimizing on-site job execution using the system.

FIGS. 2A-2D illustrate a detailed process at the project initiation phrase from the step of company bidding the job to the step of loading all the information into the interactive on-field job optimization tool.

FIGS. 3A-3F are flowcharts of the steps and options to enter progress in the project optimizing system. The chart shows detailed instructions on using the user interactive on-filed job optimization tool to enter the process of the project.

FIGS. 4A-4F are flowcharts of the steps and decision-making trees for allocating labor hours for the project using the system for optimizing the project execution. The chart shows detailed instructions on using the user interactive on-filed job optimization tool to allocate the labor hours via the user interface of the optimization tool.

FIGS. 5A-5C are flowcharts of the steps and decision-making trees for allocating equipment hours for the project using the system for optimizing the project execution. The chart shows detailed instructions on using the user interactive on-filed job optimization tool to allocate the equipment hours via the user interface of the optimization tool.

FIGS. 6A-6C are flowcharts of the steps and decision-making tree for allocating materials for the project using the system for optimizing the project execution. The chart shows detailed instructions on using the user interactive on-filed job optimization tool to allocate the materials used in the project via the user interface of the optimization tool.

FIGS. 7A-7I are flowcharts of the steps and decision-making trees for timeclocking the on-field employees, and generating transactions to the server. The chart shows detailed instructions on using the user interactive on-filed job optimization tool to generate timeclock transactions for the project via the user interfaces of the optimization tool and the server.

FIG. 8 is the flowchart of submitting the timeclock transactions to the server via the network connection using the user interactive on-filed job optimization tool.

### DETAILED DESCRIPTION OF THE INVENTION

As used herein in the specification, “a” or “an” may mean one or more. As used herein in the claim(s), when used in conjunction with the word “comprising”, the words “a” or “an” may mean one or more than one.

As used herein “another” or “other” may mean at least a second or more of the same or different claim element or components thereof. Similarly, the word “or” is intended to include “and” unless the context clearly indicates otherwise. “Comprise” means “include.”

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

As used herein, the terms “computer”, “computing device”, “computer system” or “electronic device” refers to one or more machines that comprise at least a memory, a processor, a display, one or more interfaces and at least one wired and/or wireless network connection. An electronic device or computer may comprise a desktop or laptop machine or computer or other electronic media, for example, a smartphone or tablet, as are standard and currently known in the art. As such a computer may comprise a user input device such as a keyboard, keypad, touch screen, mouse, trackball, camera, microphone, and/or other like user input device. Without being limiting, any software, modules, applications, add-ons, plug-ins, programs and/or databases, etc. necessary for implementation of the hazardous materials incident location system may be programmed into the system, may be retrieved over the network connection or may be retrieved from a non-transitory machine-readable, such as computer readable, storage device tangibly storing the same, may be tangibly stored in computer memory or other electronic media memory and are executable by the processor.

As used herein, the terms “widget” or “toggle” refer to those parts of the system, interactive tool or interface as described herein that allows 5 a user to interface with the same. As defined and known in the art this may include, but is not limited to, buttons, radio buttons, dialog boxes, pop-up windows, pull-down menus, icons, scroll bars, resizable window edges, progress indicators, selection boxes, windows, tear-off menus, menu bars, toggle switches and forms.

As used herein, the term “FOMA” refers to an interactive mobile tool for on-site job optimization.

As used herein, the term “FOSA” refers to an interactive server tool for on-site job optimization”.

As used herein, the term “job” refers to an activity with which a company is engaged to complete for a client.

As used herein, the term “pay item” refers to a core element of the overall job for which the company will be paid. For example, for a job of highway extension, a “pay item” can be “clearing site” for the highway extension.

In one embodiment of the present invention there is provided a system for optimizing the on-site job execution and management for a team or an organization comprising a job bid management system; an electronic mobile device having at least a processor, a memory and a display coupled to the processor; at least one network connection; an equipment monitoring system; an interactive mobile tool for on-site job optimization coupled to the electronic device; an enterprise resource planning system; a server machine having at least a processor, a memory and a display coupled to the processor; a project planning system; an external weather module interfaced with the interactive mobile tool; a document imaging system; an interactive server tool for on-site job optimization coupled to the server and communicably connected to the bid management system, the equipment monitoring system, the interactive on-site job optimization mobile tool, the enterprise resource planning system, said project planning system, said document imaging system and via the network connection.

In this embodiment, the interactive mobile tool for on-site job optimization comprises a user interface comprising a plurality of activatable widgets, toggles, and input windows; a plurality of databases accessible by the interactive server tool and said activatable widgets, toggle, input windows, a displayable interactive base map coupled to the databases, the activatable widgets, toggles and input window; and a weather application coupled with the map. The widgets, toggles and input windows are configured to query and/or modify the databases containing the data related to user-selected project or job.

In this embodiment, the database comprises the information of job status, job location, job work breakdown structure and specifications, weather on the job-site, employees assigned to the job, equipment assigned to the job, material usage for the job, labor hours, equipment hours, purchase orders issued in the field, user comments and daily reports for the job.

In this embodiment, the displayable interactive base map displays the job locations and geographic fence for each job. The weather tool is configured to displays the weather information and forecast on a job site.

In this embodiment, the interactive mobile tool is configured to receive the data and information related to one or more jobs from the interactive server tool; store and categorize these data and information in the electronic mobile device; receive the user's input and changes on the data and information via the interface of the interactive mobile tool; update the data and information related to one or more jobs in the database according to user's input and changes; transmit the updated data information to the interactive server tool; and generate and submit daily report for the one or more jobs to the interactive server tool.

In this embodiment, the interactive server is configured to receive the initial data and information related to the one or more jobs; store and categorize these data and information in the databases; authorize the security limits for each interactive mobile tools to access and modify the data and information related to the one or more jobs; transmit the initial and updated data and information related to the one or more jobs to the interactive mobile tool installed on the electronic mobile device; and receive updated data and information related to the one or more jobs from interactive mobile tool and update the databases. In this embodiment, the interactive server tool further comprises a mid-ware configured to interface said interactive server tool with multiple types of enterprise resource planning system, bid systems, and project planning software.

In this embodiment, the initial data and information of the one or more jobs is obtained from the bidding system, the enterprise resource planning system, the equipment monitoring system and an external weather service.

In another embodiment of the present invention, there is provided a user-implemented method for optimization of on-site job management, comprising the steps of loading the initial data and information related to one or more jobs to the interactive server tool described supra; setting up the security limits and access rights for the interactive mobile tools via the interactive server tool; synchronizing all the data and information related to one or more jobs to one or more authorized interactive mobile tool described supra; clocking field employees in and out of job throughout the day using the interactive mobile tool; submitting the timeclock transactions to the interactive server tool; monitoring the equipment information on the job via the equipment monitoring system throughout the day; synchronizing all the updated data and information related to the one or more jobs from previous day; entering the progress for previous day via the interface of the interactive mobile tool; allocating labor hours and equipment hours to tasks; entering material usage; entering purchase orders as needed; submitting daily report and transmitting the updated data to the interactive server tool from the interactive mobile tool; and generating import files for the enterprise resource planning system and payroll system.

In this embodiment, the initial data and information loaded to the interactive server tool is extracted from the enterprise resource planning system and the equipment monitoring system. The initial data and information extracted from the enterprise resource planning comprises job work breakdown structure, personnel information. Preferably, the initial data and information extracted from the equipment monitoring system comprises geographic fences, equipment locations, equipment photos, idle hours for the equipment, and maintenance information for equipment. Preferably, the personnel information comprises image of each employee, total hours worked for each employee, unallocated work hours for each employee, and crews containing a group of employees.

In this embodiment, security limits and access rights for the interactive mobile tools preferably comprises permission for time overrides, accessibility to selected jobs, accessibility to crew section of the personnel information, and permission to create and change a crew for a job. In this embodiment, the employees are clocked in and out of the job using the facial recognition technology to authenticate the information of said employees.

In this embodiment, allocating labor hours to the tasks comprises the steps of synchronizing the data of labor hours from the interactive server tool to the interactive mobile tool; inquiring the worked hours and unallocated hours for each employee or crew via the interactive mobile tool; assigning the employee or crew with unallocated hours to a task; and submitting the allocation of labor hours to the interactive server tool. Preferably, allocating equipment hours to the tasks comprises the steps of: synchronizing the data for equipment from the interactive server tool to the interactive mobile tool; inquiring the information of a piece of equipment including the location of the equipment, worked and idle hours, and maintenance information of the equipment via the interactive mobile tool; assigning the equipment with unallocated hours to a task based on the information; and submitting the allocation of equipment hours to the interactive server tool. Preferably, allocating material to the tasks comprises the steps of synchronizing the data for material usage from the interactive server tool to the interactive mobile tool; inquiring the information of material usage against tasks including image of each material, and nominated usage for each material based on progress entered against the tasks; entering the actual usage of said material in the interface of the interactive mobile tool; adding comments based on the difference between nominated material usage and the entered actual usage; and submitting the allocation of equipment hours to the interactive server tool.

Provided herein is a system and method that comprises an electronic device, a server and an interactive tool for on field project optimization available to acquire data of the project from the input of a user and synchronization of the server of the system. This program incorporates job information module including weather, job map etc., data transfer module to synchronize the data between the electronic device and the server, resource allocating module to allow the users to allocate labor hours, equipment and, report-generating module to create and submit daily reports to the server. It can be used to optimize and monitor the operation of on-site jobs for higher working efficiency. Users can also query, change and report all the incidents happened in a job site.

Particularly, the system displays real time and historical information about a project, including but not limited to, geo-fence, weather conditions, assigned employees and equipment. A user of the system can allocate labor hours, equipment and materials according to the nominated usage and actual historical data, and synchronize the real time data with the server via network connection.

As described below, the invention provides a number of advantages and uses, however such advantages and uses are not limited by such description. Embodiments of the present invention are better illustrated with reference to the Figure(s), however, such reference is not meant to limit the present invention in any fashion. The embodiments and variations described in detail herein are to be interpreted by the appended claims and equivalents thereof.

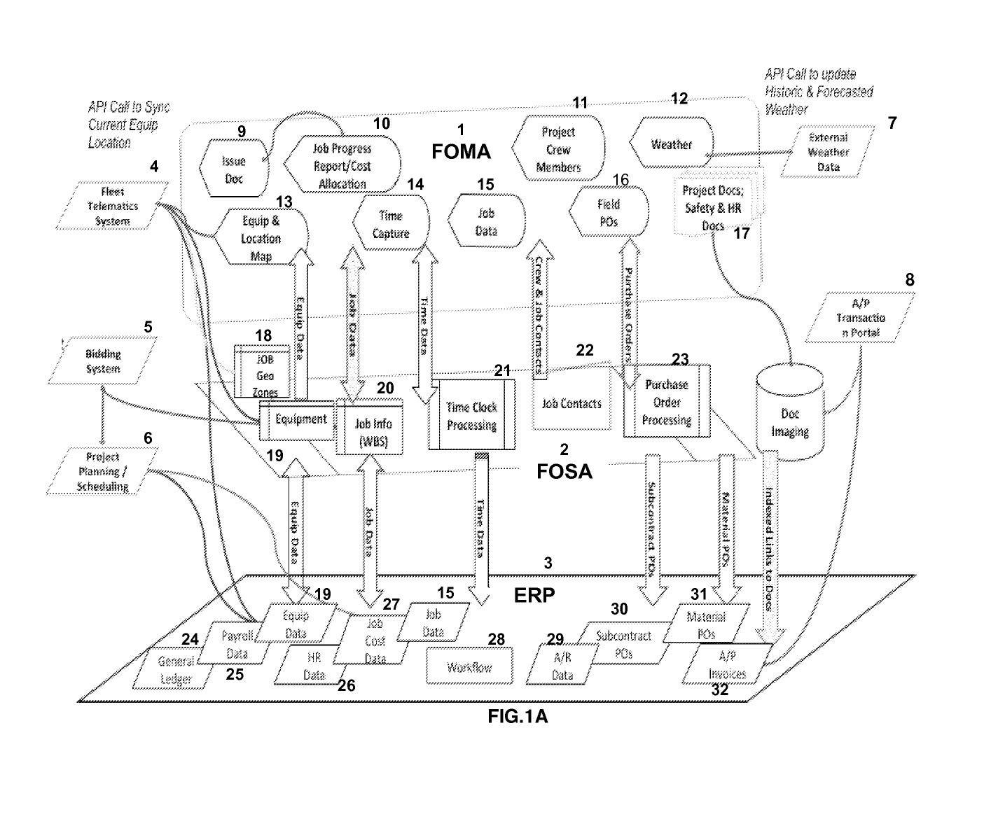

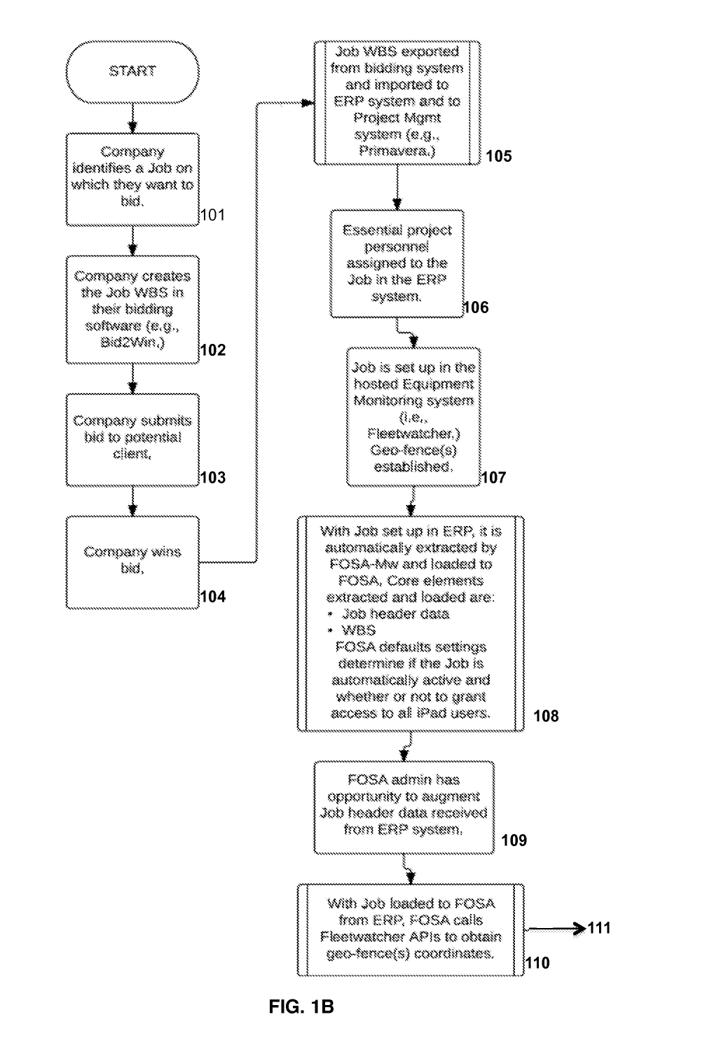

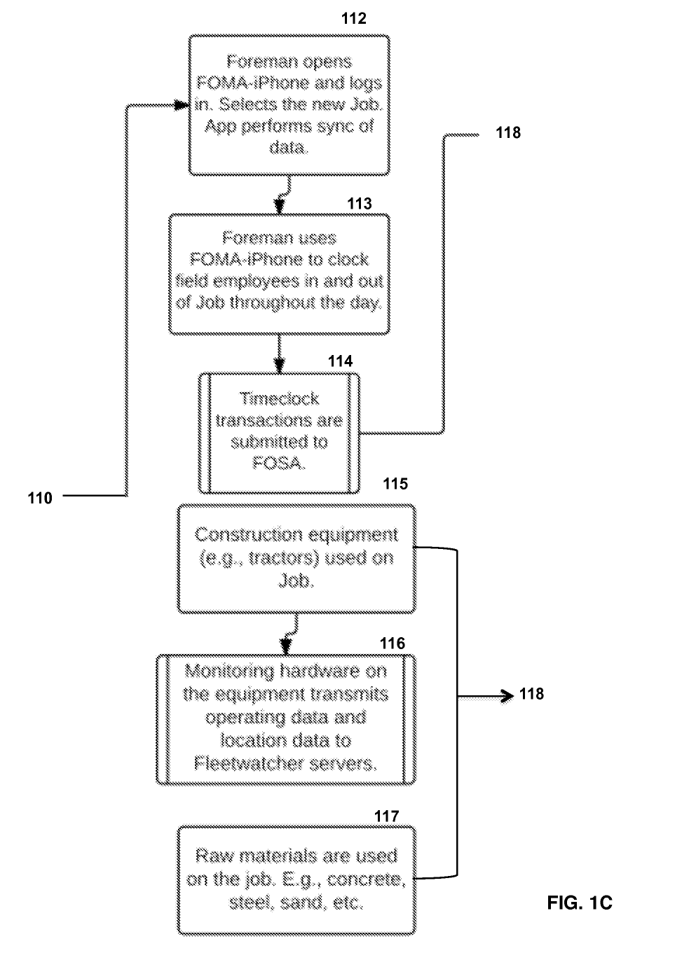

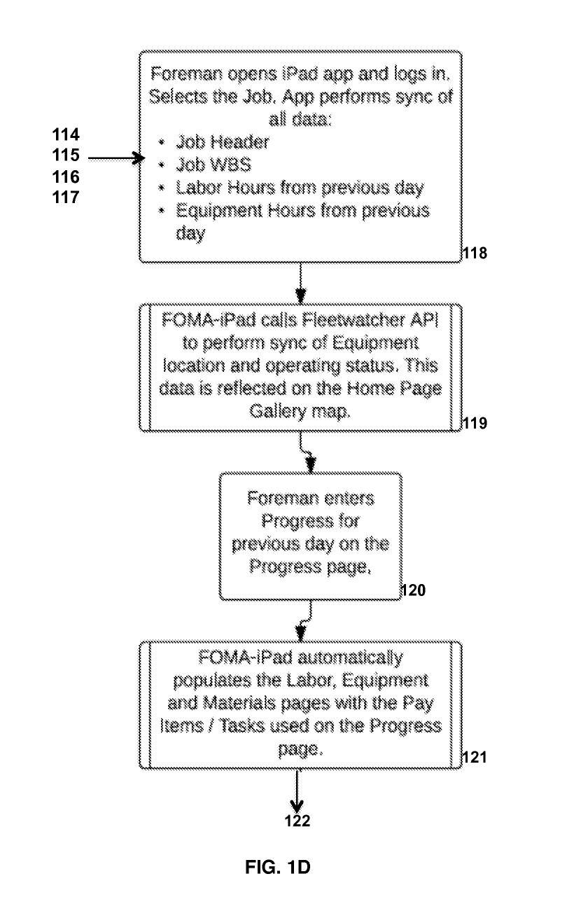

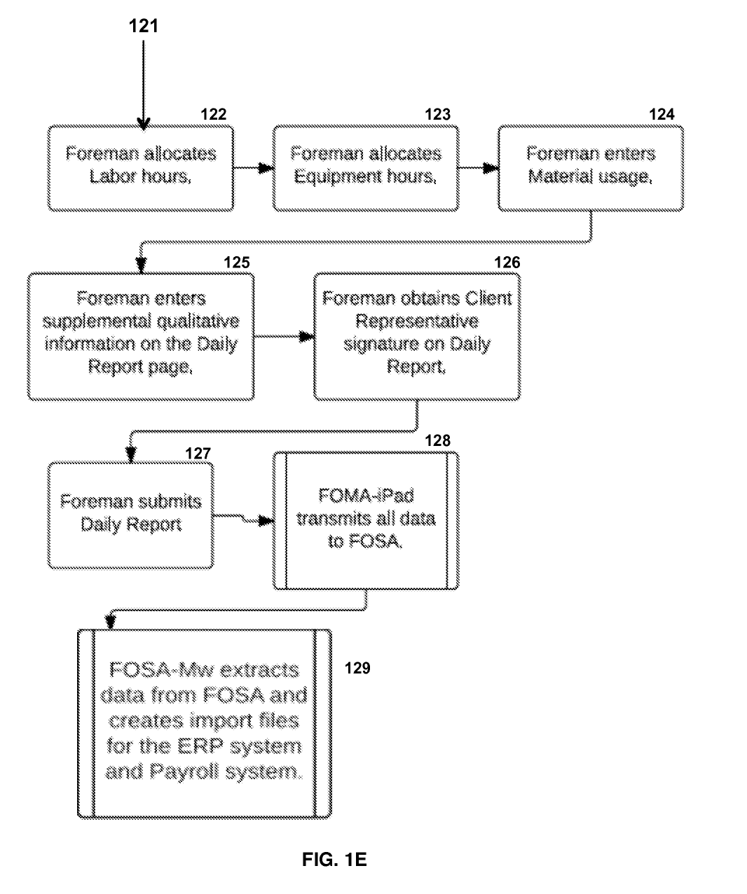

FIG. 1A is an overview chart depicting the various components of the system for on-site job optimization. The chart further illustrates the various integrations to existing system data required which will be delivered with the FOMA and FOSA components. Overall, the three key components for this system are an interactive mobile tool for on-site job optimization (FOMA) 1, an interactive server tool (FOSA) 2, and an enterprise resource planning system (ERP) 3. Other components include a fleet telematics system (equipment monitoring system) 4, bidding system 5, a project planning scheduling system 6, a module that provides weather data 7 and an accounts payable transaction portal 8. The data/information in the interactive mobile tool 1 includes the issue documents 9, job progress report/cost allocation 10, project crew members 11, weather information 12, equipment and location map 13, time capture 14, job data 15, field purchase orders 16, and project, safety and human resource documents 17.

The interactive server tool (FOSA) 2 contains the information/data of job geo-zones 18, equipment information/data 19, job information (work breakdown structure) 20, time clock processing 21, job contacts 22 and purchase order processing 23. The information/data in the enterprise resource planning system includes general ledger 24, payroll data 25, equipment data 19, human resource data 26, job cost data 27, job data 15, workflow 28, accounts receivable (NR) data 29, subcontract purchase orders 30, material purchase orders 31, accounts receivable invoices 32. The information of equipment and location map 13 in the mobile tool 1 is obtained from the equipment monitoring system 4 and data synchronization with the server tool 2. The interactive server tool 2 exchanges the job data 15 and the equipment data 26 with the enterprise resource planning system 3, sending time data 21, subcontract purchase orders 30, material purchase orders 31 to the enterprise resource planning system 3. The interactions between the interactive server tool and mobile tool include exchanging job data 15, time data 14, 21 and purchase orders 16, 23, transferring crew and job contacts 22, and equipment data 19 from the server tool 2 to the mobile tool 1.

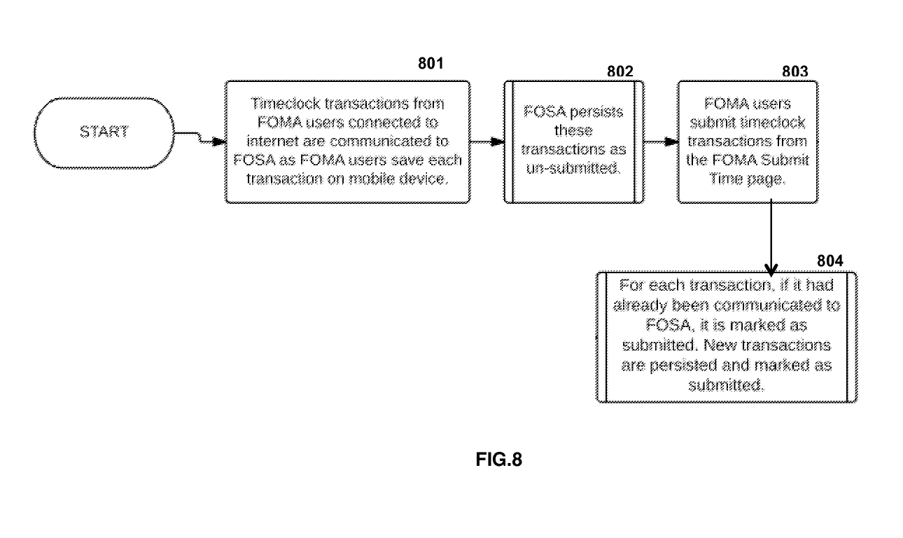

The equipment monitoring system (fleet telematics system) 4 sends equipment location map 13 to the mobile tool 1, the job geo zone 18 to the server tool 2, equipment information/data 19 to both the server tool 2 and the enterprise resource planning system 3. The bidding system 5 transfers equipment information 19 and work breakdown structure 20 to the server tool. The project planning/scheduling module 6 relays the equipment data 19 and job cost data 27 to the enterprise resource planning system 3. The accounts payable transaction invoice portal 8 is transferring invoices 32 to the enterprise resource planning system 3. The components in the system utilize WIFI and cellular data service connectivity to connect each other and uniquely deliver data and information (see FIG. 1B thru FIG. 8) and, ultimately, optimize job performance at the field level.

FIGS. 1B-1E are flowcharts illustrating a general process of on-site job optimization from bidding the job to submit the daily report. Generally, the process comprises bidding process, pre-construction process, job execution (for Day 1 and Day 2). The bidding process starts with the company identifies a job to bid 101 and submits job work breakdown structure to potential client for bidding 103. After the company wins the bid 104, the pre-construction process starts. The work breakdown structure for this job is loaded into the project management system and enterprise resource planning system 105, in which the essential project personnel is assigned 106. The job is then set up in the hosted Equipment Monitoring System with the geo-fences of the job established 107. The interactive server tool for on-site job optimization then automatically extracts the job information and default settings to determine if the job is automatically active and whether to grant access to all the users of the electronic device loaded with the interactive mobile tool for on-site job optimization 108. The administrator of the server has the opportunity to augment job header data 109 and obtain the equipment information and the geo-fences coordinates via the interface of the on-site job optimization tool on the server 110.

For the job execution process, a user, often the job foreman, selects the new job and synchronizes the job data with the server via the interactive mobile tool for on-site job optimization installed on the electronic device 112, such as a smart phone or a tablet. The user or foreman then clock field employees in and out of job through out the day via the interactive mobile tool on the electronic device 113 and submits the timeclock transactions to the server 114. Throughout the first day for the job, the equipment monitoring system transmits operating data and location data to the interactive server tool coupled with a server computer 115, 116. Information on usage of raw materials is also recorded and submitted to the server 117.

In the next day of the job execution, the foreman uses the interactive mobile tool for on-site job optimization on the electronic device to synchronize all the data 118, including but not limited to job header, job work breakdown structure, labor hours from the previous day, equipment hours from the previous day, from the server. The user or foreman also synchronizes the data of equipment location and operation status from the server, which extracted the equipment data from the equipment monitoring system 119. The user or foreman then enters progress for the previous day via the user interface of the on-site job optimization tool on the electronic device 120, which subsequently, automatically displays the job progress, hours worked, & equipment hours for allocation to specific Pay items and Tasks 121.

The user or foreman then allocates the labor hours 122 and equipment hours 123 and enters material usage 124 via the interface of the on-site job optimization tool on the electronic device and enters supplemental qualitative information 125 via the report-generating module. After the client representative signature on the daily report 126 is obtained, the user or foreman submits the daily reports 127 along with all the data of the job generated throughout the day 128 via the interactive mobile tool for on-site job optimization on the electronic device to the interactive server tool. The final data was extracted from the server and import files for the enterprise resource planning system and payroll system are generated based on these data 129.

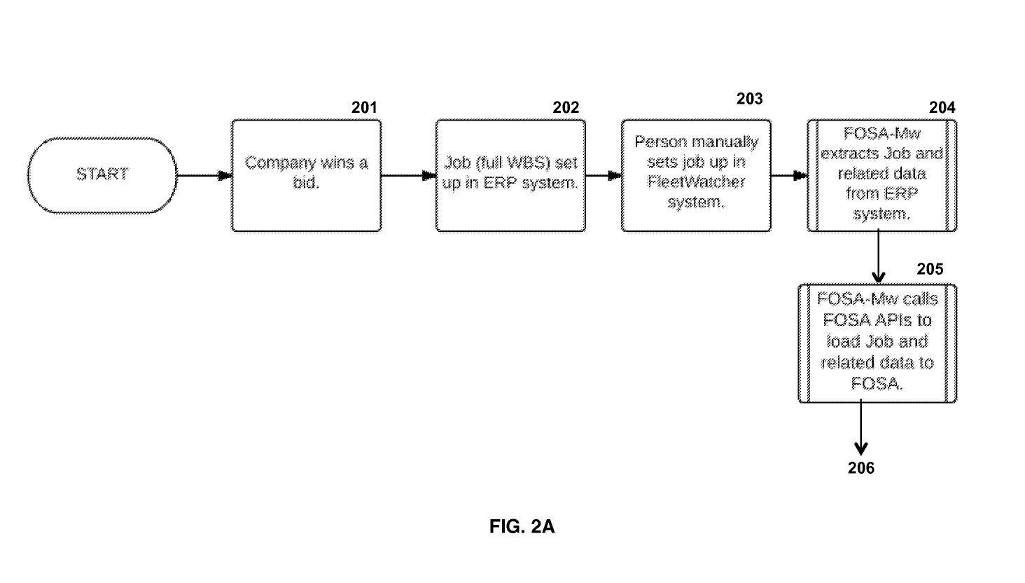

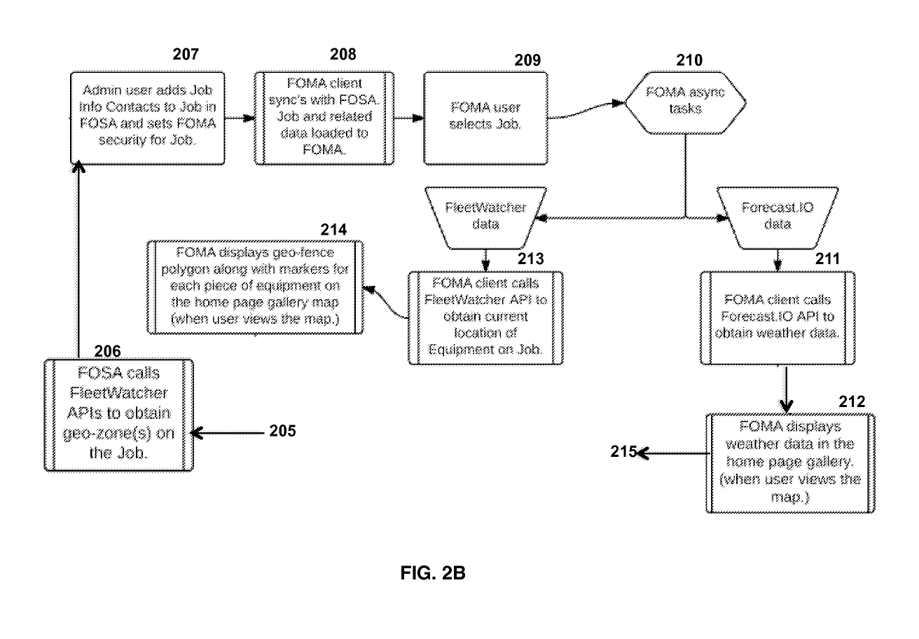

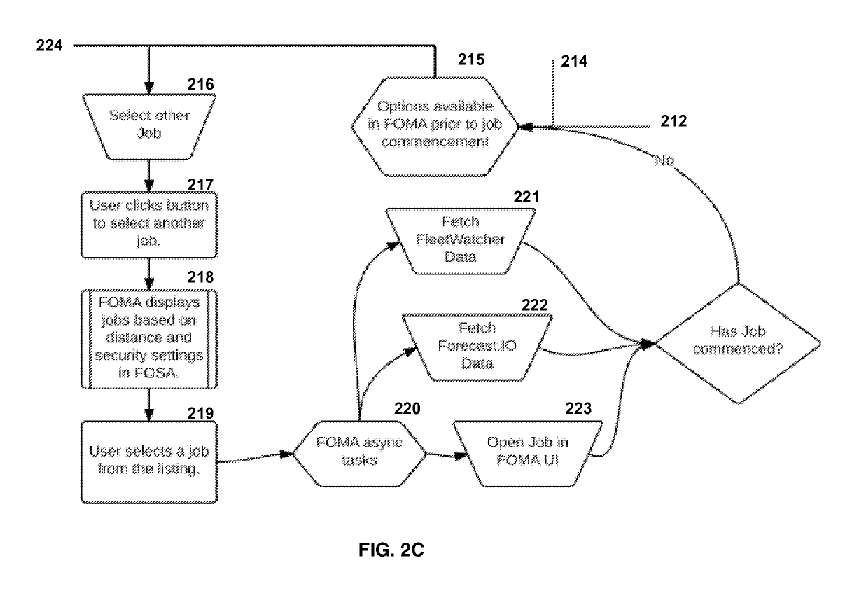

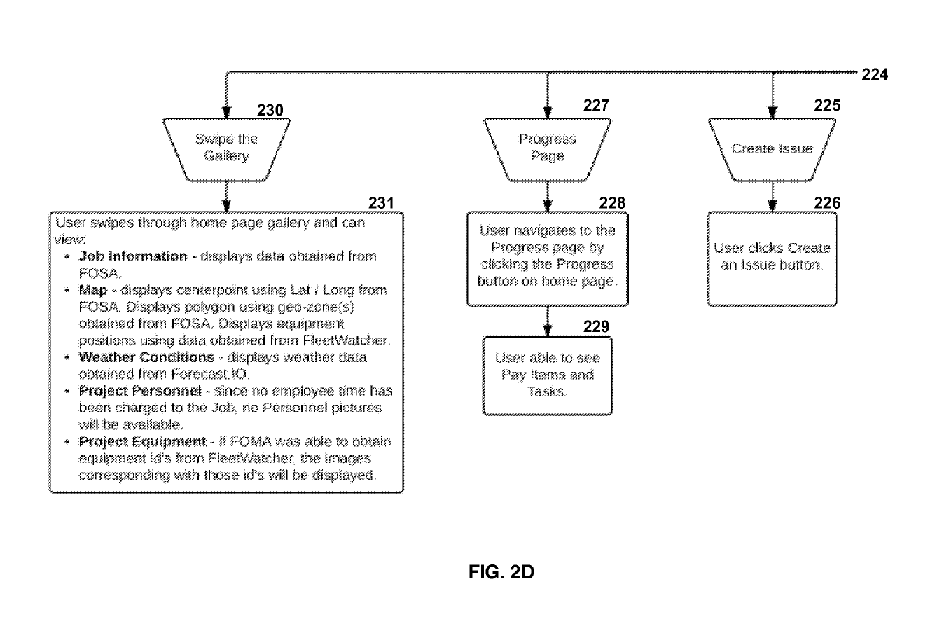

FIGS. 2A-2D are flowcharts of the detailed process at the project initiation phrase from the step of company bidding the job to the step of loading all the information into the interactive mobile tool for on-field job optimization. The company wins a bid 201 and the work breakdown structure of the job is set up in the enterprise resource planning system 202. A user manually sets the job up in the equipment monitoring system 203. The interactive server tool for on-field job optimization coupled with the server computer extracts 204 and obtains the job and related data 205 including the geo-fences of the job. The administrator of the server adds job information and contact information to the interactive server tool and sets the security limits for the electronic device with the interactive mobile tool 207. The user of the electronic device synchronizes the data form the server to the device 209 and selects a job 210. The user then uses the interactive mobile tool for on-field job optimization on the electronic device to obtain the weather data 211 and mobile tool displays weather data on the homepage of the interface 212 when user views the map. At the same time, the user retrieves the current location of the equipment for the job and the interactive mobile tool for on-field job optimization displays geo-fence polygon along with markers for each piece of equipment on the map 213, 214.

The user then has several options to operate the on-field job optimization tool before selected job starts 215. For the first option, the user can swipe the widgets on the home page gallery to view the job information that is obtained from the server 230, map that displays center point using latitude/longitude from the server, the polygon using geo-fences obtained from the server and equipment positions, weather conditions that displays weather data obtained, project personnel which will not display personnel pictures before the job commences or before time has been recorded to the job, project equipment with images with corresponding ID's obtained from the equipment monitoring system 231.

As a second option, the user can enter the progress page 227 by clicking the progress button on the home page of the user interface of the interactive mobile tool for on-field job optimization 228 and the user is able to see the content of Pay Items and Tasks 229.

As a third option, the user clicks “Create an Issue” button on the home page of the interface to generate an issue 225, 226.

As a fourth option, the user can select another job 216 by clicking the button on the home page 217. The jobs sorted by distance and security permission set in the server are displayed on the interface of the interactive mobile tool for on-field job optimization 218. The user can then select a job from the listing 219 and obtain the equipment monitoring data 221, weather condition 222 and open the job 223 via the user interface of the on-field job optimization tool installed on the electronic device 220.

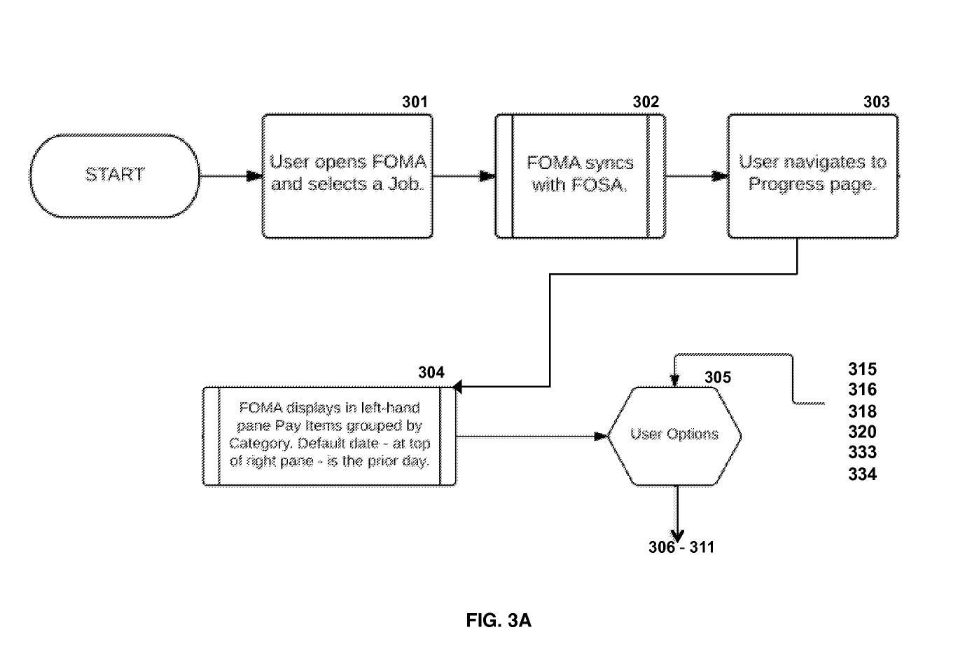

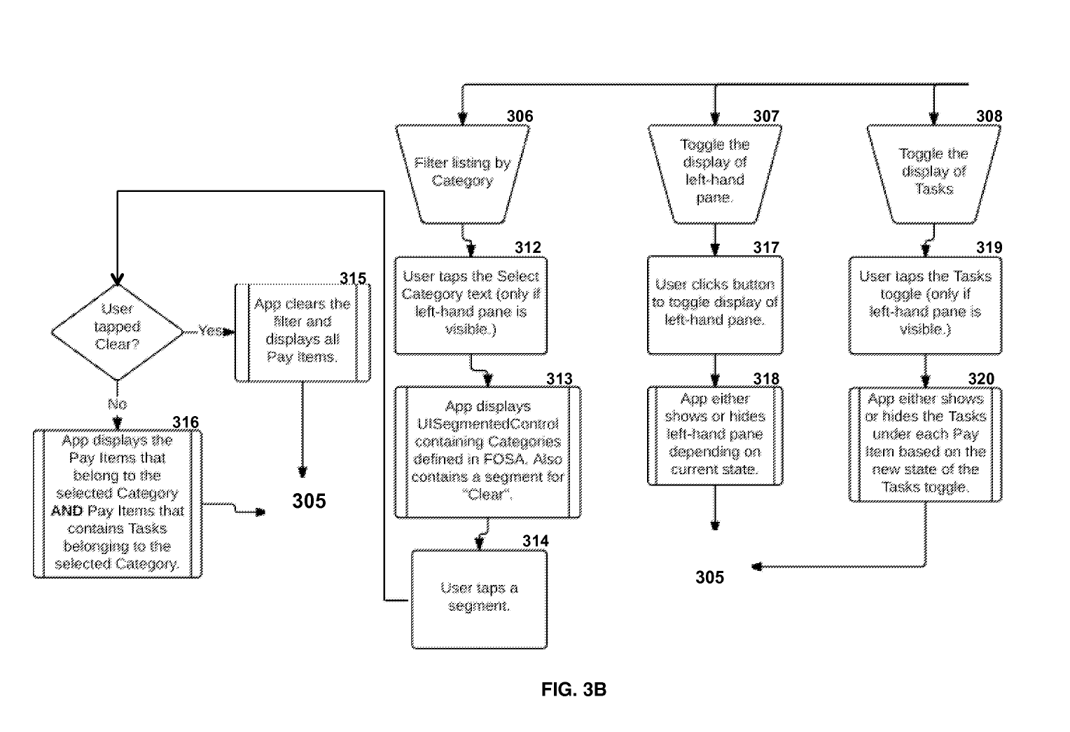

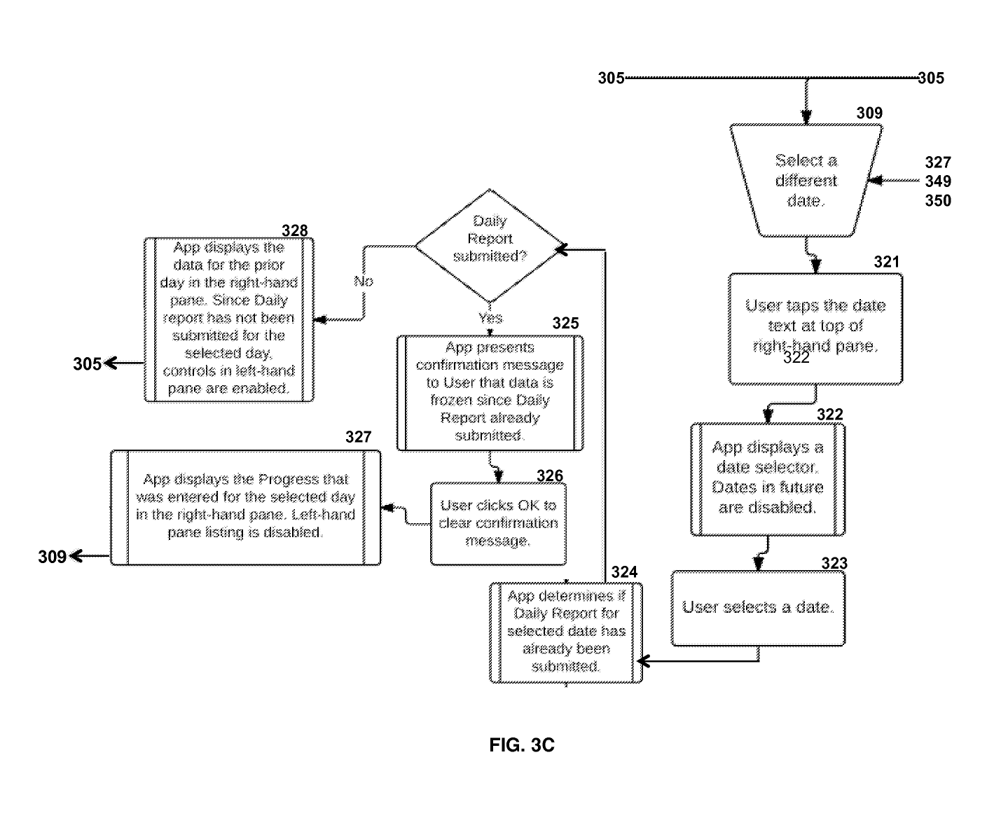

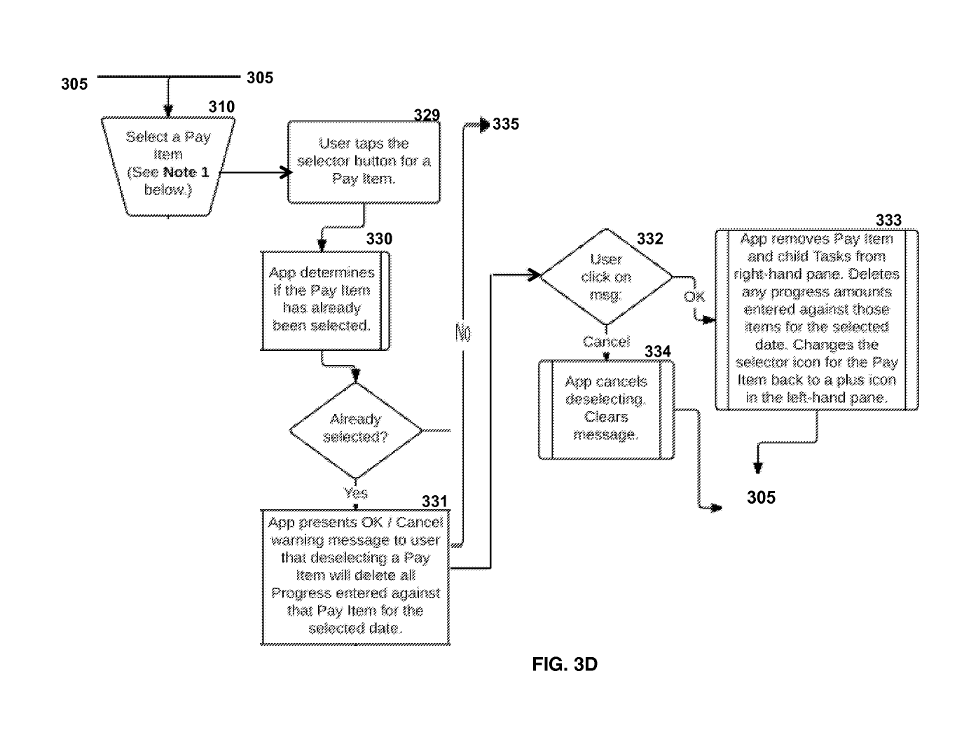

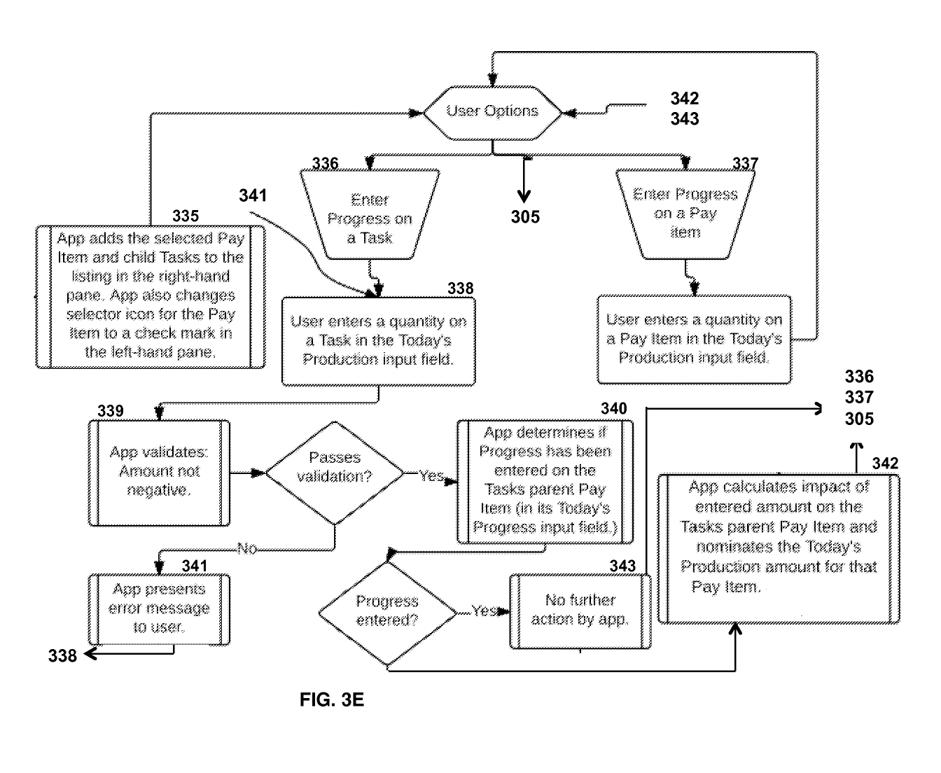

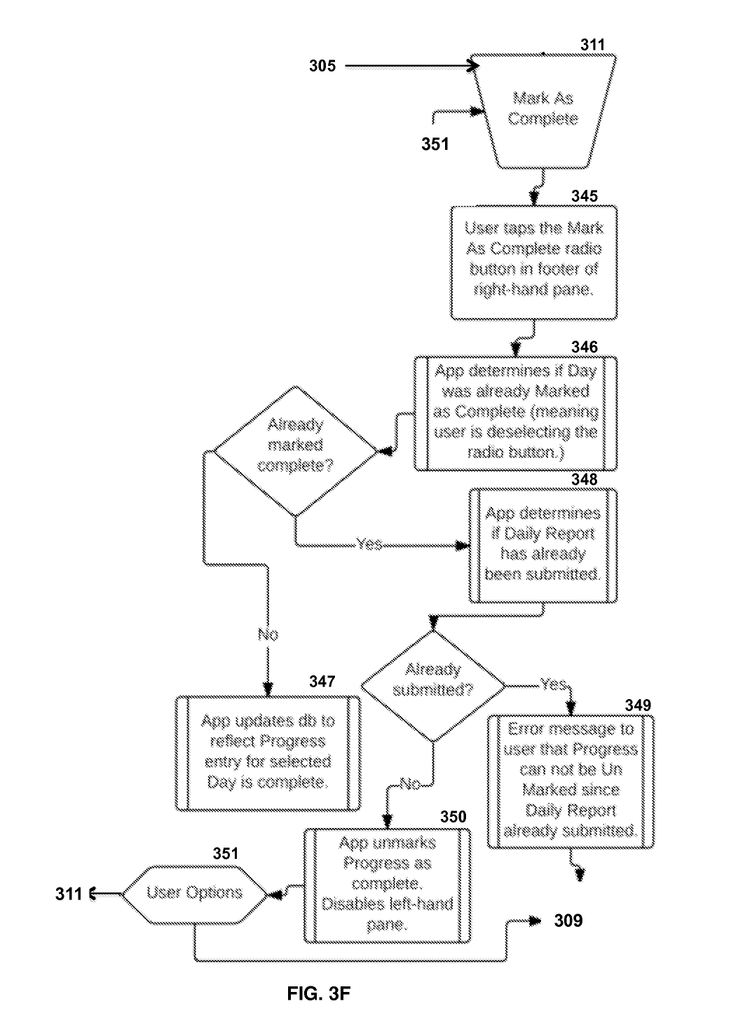

FIGS. 3A-3F are flowcharts of the steps and options to enter progress in the on-site job execution and management optimizing system. The user selects a job 301 in the interactive mobile tool for on-field job optimization installed on the electronic device, synchronizes with the server 302 and navigates to the Progress page of the user interface 303. The pay items are grouped by category 304. There are six top level menu options for the user to operate 305. For the first option, the user can filter listing 306 according to the category by tapping the “Select Category” text displayed on the user interface 312. The interface of the interactive mobile tool displays the categories 313 that are defined in the server. If the user taps a segment 314, the on-field job optimization tool clear the filter and displays all pay items again 315, returning to 305. If the user does not tap clear at this time, the interactive mobile tool displays the pay items in the selected category and pay items that contain tasks in the selected category 316.

For the second option, the user toggles the display of left-hand pane 307 in the interface of the interactive mobile tool. Then the user clicks the button to toggle display of left-hand pane 317. The interface of the mobile tool either shows or hides left-hand pane depending on current state 318, returning to 305.

As a third option, the user toggles the display of tasks 308 in the interface of the interactive mobile tool for on-field job optimization by tapping the task toggle 319 when the left-hand pane in the interface of the on-field job optimization tool is visible. The interface of the on-field job optimization tool shows or hides the tasks under each pay item based on the new state of the tasks toggle 320, returning to 305

As a fourth option, the user can select a different date 309 by tapping the date text at the top of right-hand pane 321 of the interface of the on-field job optimization tool. The interface displays a date selector while dates in the future are disabled 322. The user then select a date 323 and the interactive mobile tool determines whether daily report for selected date has already been submitted 324. If it has, the interface of interactive mobile tool presents a confirmation message to the user that the data for selected date is frozen because daily report was already submitted 325. The user clicks OK to clear confirmation message 326 and the interface displays the progress that was entered for the selected day in the right-hand pane while left-hand pane is disabled 327. The User then returns to the step 309. If it has not been submitted, the interface of the on-field job optimization tool displays the data for the prior day in the right-hand pane and controls in the left-hand pane are enabled 328. The user now returns to step 305.

As a fifth option, the user can select a pay item 310 by tapping the selector button in the interface of the interactive mobile tool for a pay item 329. The on-field job optimization mobile tool then determines if the pay item has already been selected 330. If yes, the interface presents OK/Cancel warning message to user that deselecting a pay item will delete all progress entered against that pay item for the selected data 331. The user clicks OK 332 to remove the pay item and child tasks from right-hand pane and deletes any progress amounts entered against those items for the selected date 333. The action changes the selector icon for the pay item back to a plus icon in the left-hand pane of the interface. When the user chooses to cancel 333, the on-field job optimization tool cancels deselecting and clears message 334. The user returns to step 305.

If the interactive mobile tool for on-site job optimization determines that the pay item has not been selected 330, it automatically adds the selected pay item and child tasks to the listing in the right-hand pane 335. The interactive mobile tool changes selector icon for the pay item to a check mark in the left-hand pane of the home page of the interface 335. The user then can enter progress on a task 336 and/or enter progress on a pay item 337. If the user chooses enter progress on a pay item 337, he or she can enter a quantity on a pay item in the Today's Production input field shown on the interface of mobile tool 344. After choosing enter progress on a task 336, the user enters a quantity on a task in the Today's Production input field shown on the interface of the mobile tool 338 and the mobile tool validates the amount is not negative 339. If the input amount is negative, the interface presents error message to the user 341. If it is not negative, the interactive mobile tool proceeds to determine whether progress has been entered on the tasks parent pay item 340. If yes, no action is conducted by the optimization tool 343. If not, the optimization tool calculates impact of the entered amount on the tasks parent pay item and nominates the Today's Production amount for that pay item 342.

As a sixth option, the user marks the progress as complete 311 by tapping the “Mark As Complete” radio button in the footer of right-hand pane shown in the interface of the on-field job optimization mobile tool 345. The interactive mobile tool determines if the day was already marked as complete 346. If not, the mobile tool updates the database to reflect the progress entry for selected progress is complete 347. If it was already marked as complete, the interactive mobile tool then determines whether the daily report has already been submitted for the day 348. If yes, an error message is generated to the user showing that Progress cannot be unmarked because daily report for the day is already submitted 349. The user can proceed to select a different date. If the Daily Report is not submitted, the optimization mobile tool unmarks progress as complete and disables left-hand pane of the interface 350. The user can either proceed to mark it as complete or select a different date.

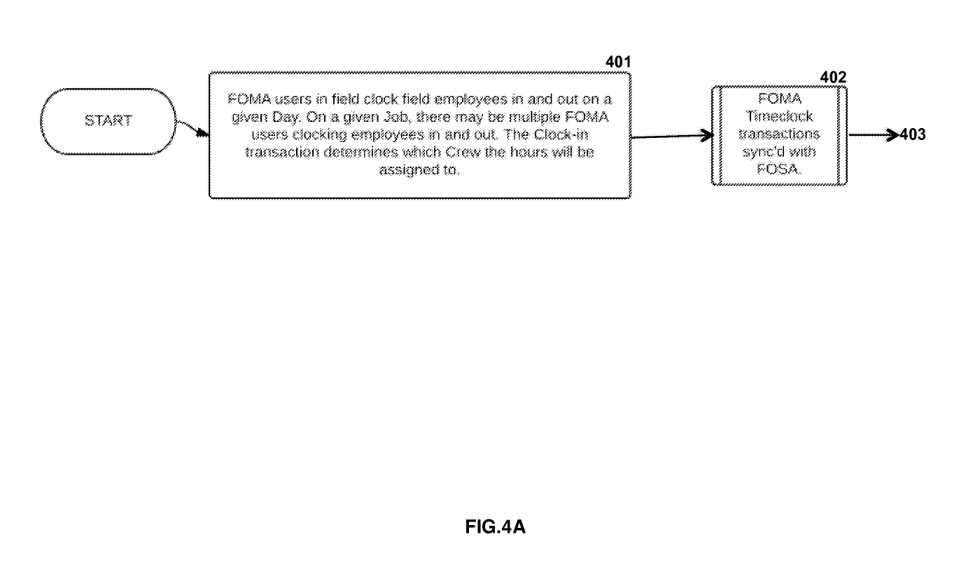

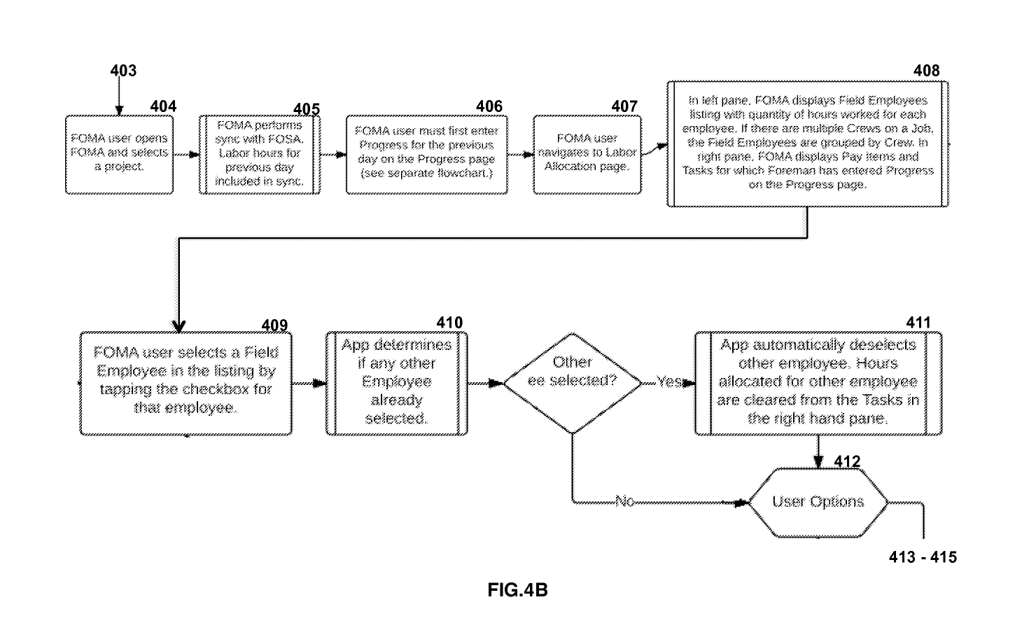

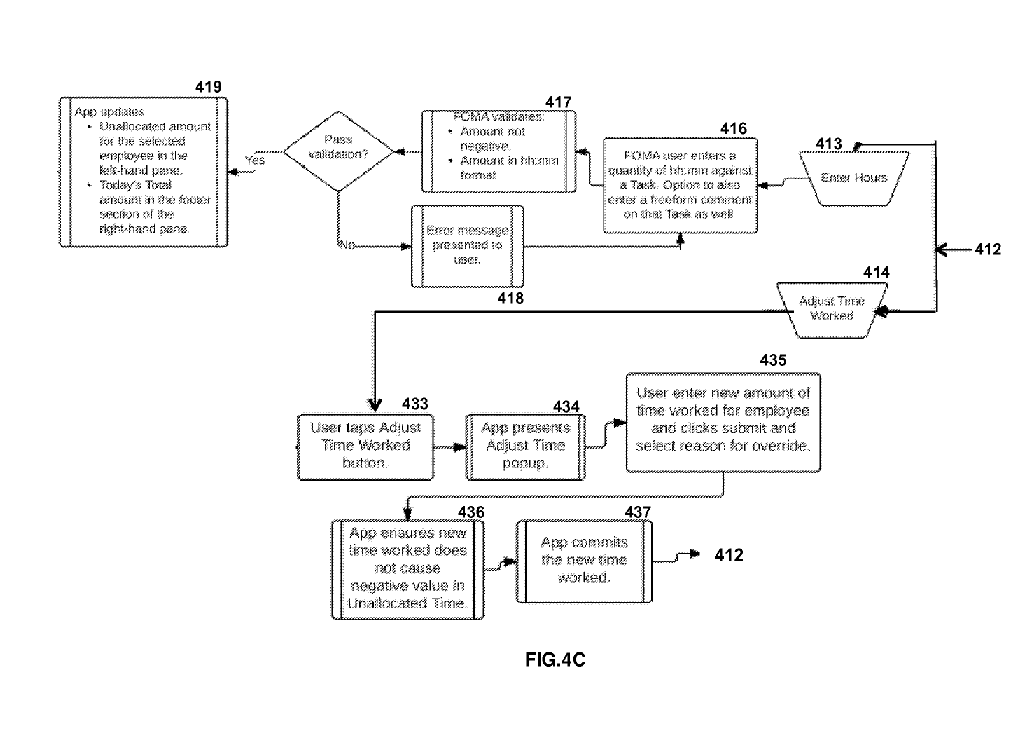

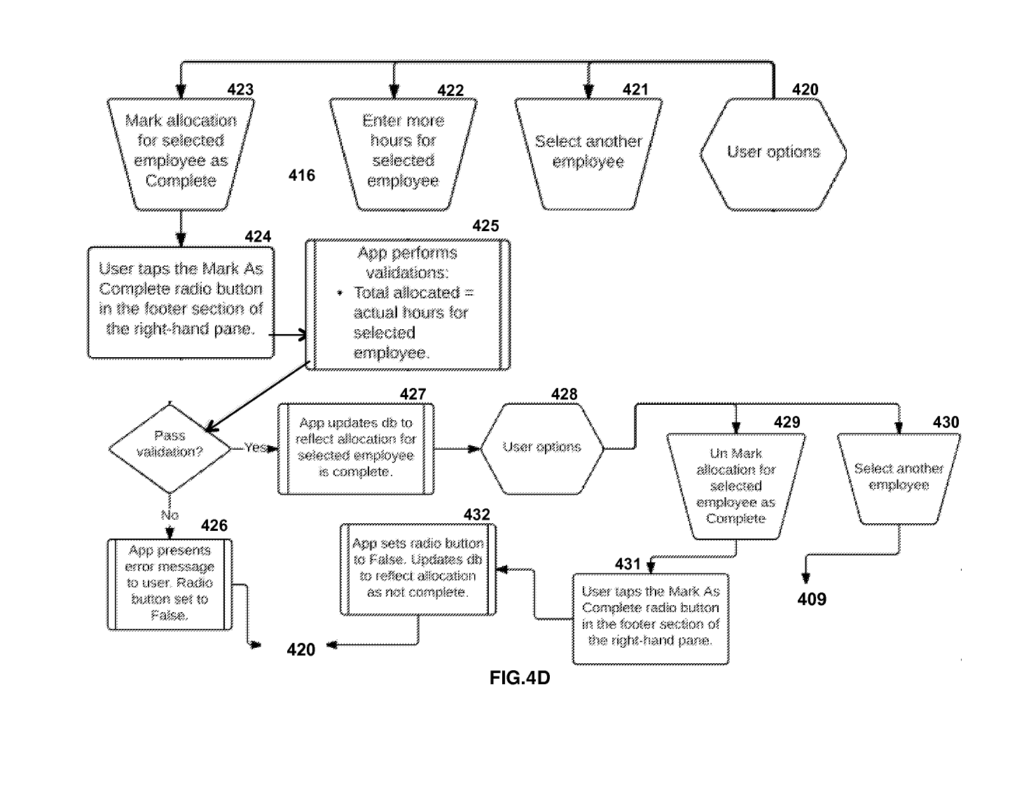

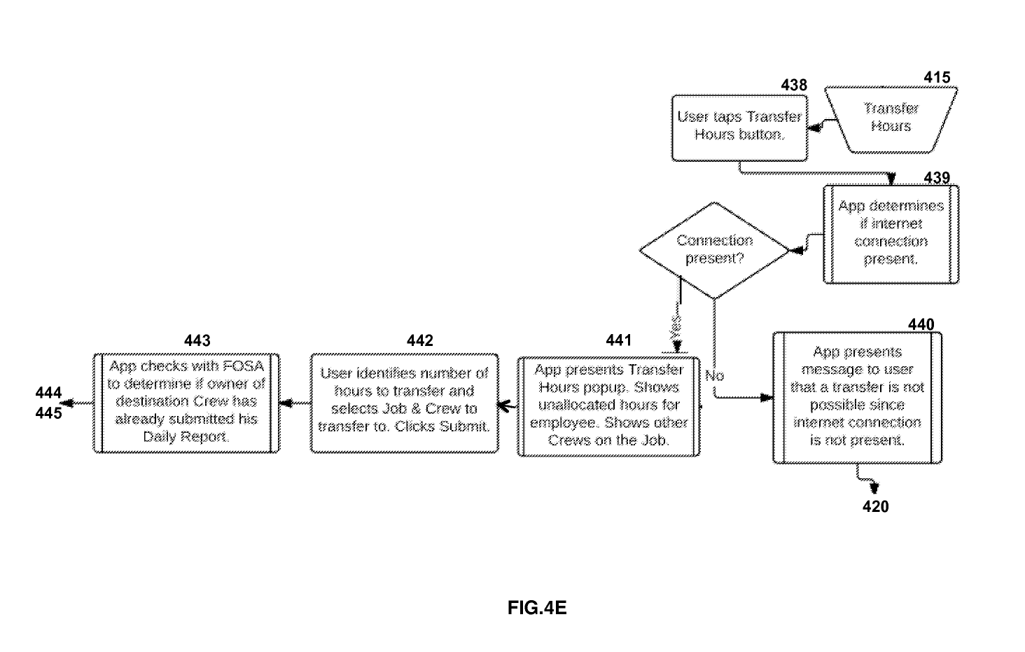

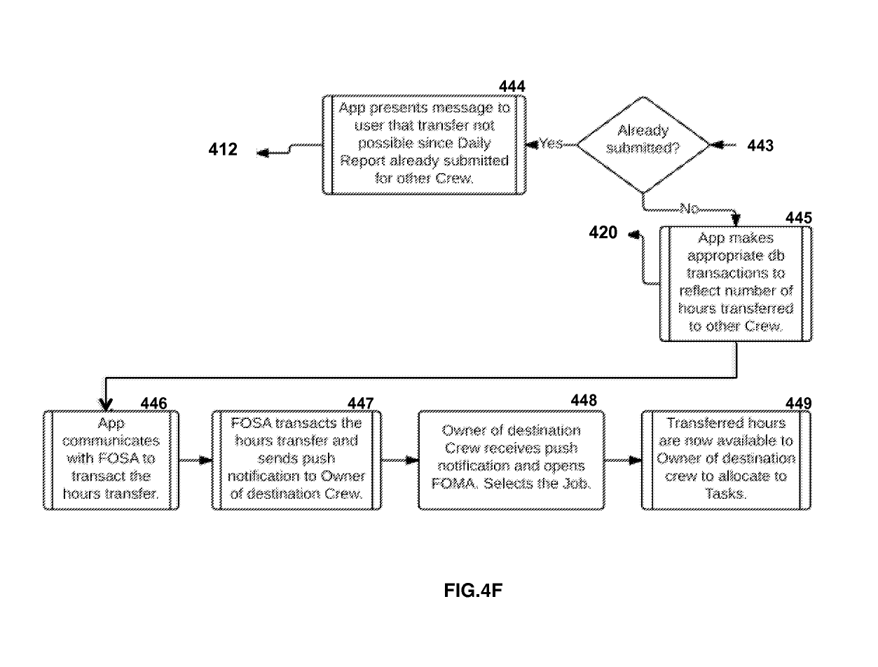

FIGS. 4A-4F are flowcharts of the steps and options for labor hour allocation. The user in the field clocks the field employees in and out on a given day. For a given job, there may be multiple users of the mobile tool installed in electronic devices clocking employees in and out. The clock-in transaction determines which crew the hours will be assigned to 401. The timeclock transaction in the interactive mobile tool is first synchronized with the data in the server 402. The user then opens the on-field job optimization tool, selects a project 404 and synchronizes the data, including labor hours for previous day, with the interactive server tool 405. After entering the progress for the previous day on the progress page of the interface 406, the user navigates to “Labor Allocation” page of the interface 407. In left pane, the optimization tool displays Field Employees listing with quantity of hours worked for each employee. If there are multiple crews in a job, the field employees are grouped by crew. In the right-pane, the interface displays pay items and tasks for which a foreman and/or a user has entered progress on the progress page 408. The user selects a field employee in the listing by tapping the checkbox for that employee 409. The interactive mobile tool determines if any other employee is already selected 410. If yes, the optimization tool automatically deselects other employee, and clears the hours allocated for other employee from the tasks in the right-hand pane 411. If no other employee is selected, the user proceeds to the next step with three options 411.

For the first option, the user can enter a quantity of time against a task and optionally a freeform comment on the task 413, 416. The interactive mobile tool validates whether the entered time is not negative, and in the format of hours:minutes. If it does not pass validation the mobile tool generates an error message and the user must enter another quantity of time 418. The user returns to step 416. If it passes the validation, the mobile tool updates unallocated amount for the selected employee in the left-hand pane and “today's total amount” in the footer section of the right-hand pane of the interface 419.

The user can then selects another employee 421, enter more hours for selected employee 422 or mark allocation for selected employee as complete 423 by tapping the “Mark As Complete” button in the footer section of the right-hand pane of the interface 424. The interactive mobile tool then validates that total allocated hours are equal to actual hours for selected employee 425. If not, the mobile tool automatically generates an error message 426. If it passes the validation, the mobile tool completes the updates of the database to reflect allocation for selected employee 427. Then, the user can select another employee 430 or unmark allocation for selected employee as complete 429 by tapping the “Mark As Complete” radio button in the footer section of the right-hand pane 431. The interactive mobile tool then sets the radio button to “False” and updates the database to reflect allocation as not complete 432. The user returns to the step 420.

For the second option, the user taps the “Adjust Time Worked” button 433 and an “Adjust Time” popup window is shown on the interface 434. The user enters a new amount of time worked for employee, clicks “submit” and select reason for override 435. The interactive mobile tool ensures updated work hours does not cause negative value in unallocated time 436 and commits the newly completed work hour by the employee 437.

For the third option, the user taps “transfer hours” button 415, 438 in FIG. 4E and the interactive mobile tool determines if Internet connection is present 429. If there is no internet connection, the interactive mobile tool generates a message to remind the user that a transfer is not possible without Internet connection 440. If there is an internet connection, the mobile tool presents a transfer hours popup window and shows unallocated hours for employee and other crews on the job 441. The user then identifies the number of hours to transfer and selects job and crew to transfer to and clicks “Submit” button 442. The interactive mobile tool subsequently checks with the server to determine if the owner of destination crew has already submitted his daily report 443. If yes, the mobile tool generate a message to the user that transfer not possible since daily report already submitted for other crew 444. If not, the mobile tool then makes appropriate database transactions to reflect the number of hours transferred to other crew 445 and communicates with the server to transact the hour transfer 446. The server then subsequently sends a push notification to the owner of destination crew 447. The owner receives the notification and opens the interactive mobile tool on the electronic device and selects the job 448. The transferred hours are now available to owner of destination crew to allocate to tasks 449.

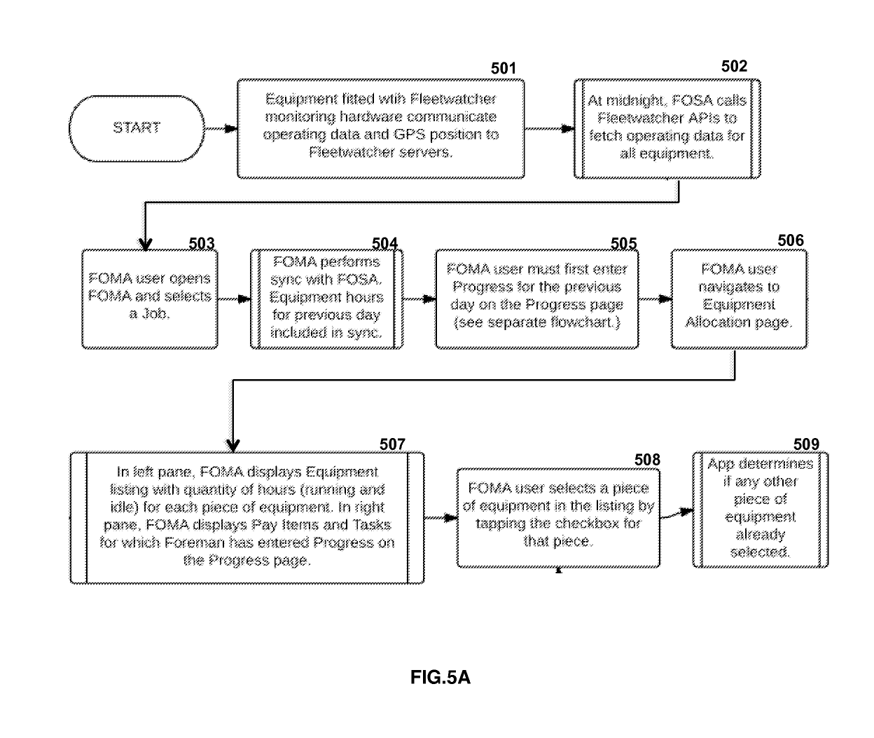

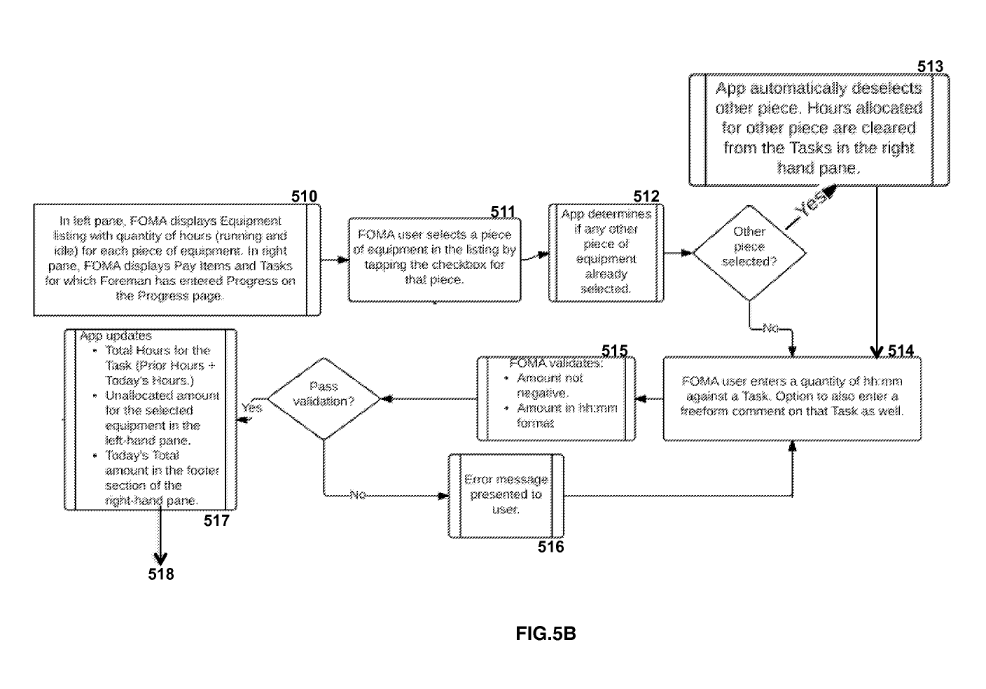

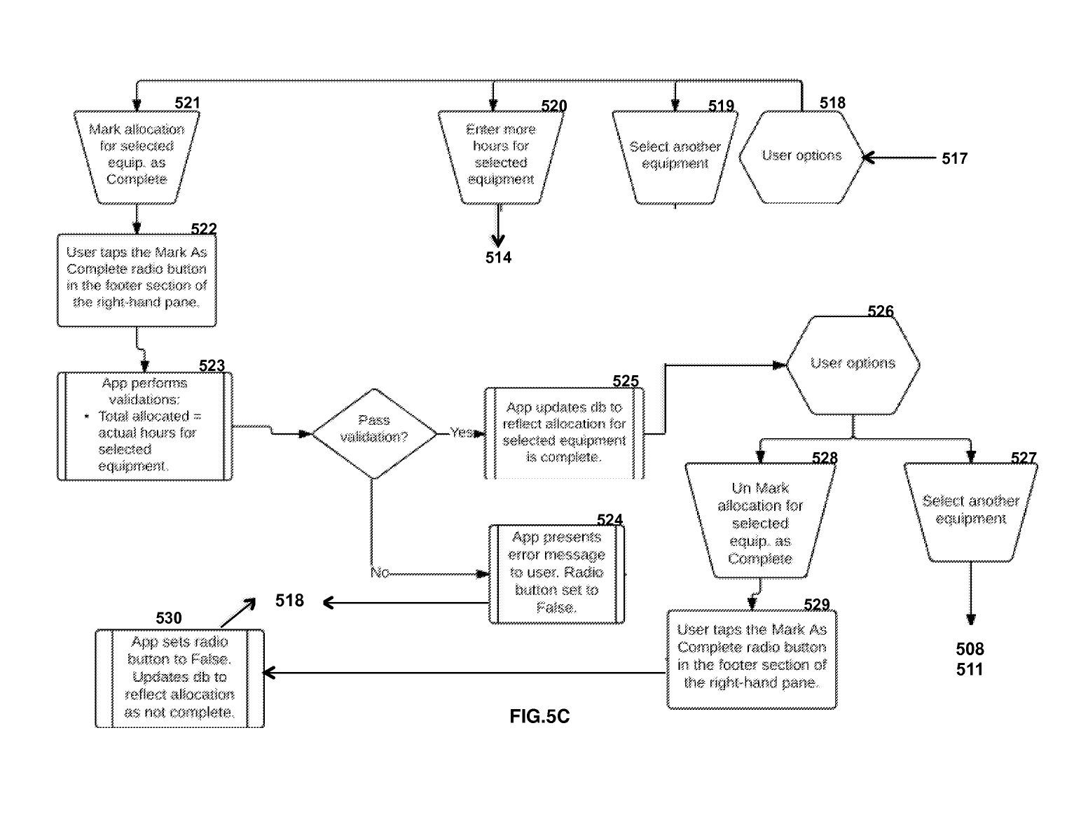

FIGS. 5A-5C are flowcharts of the steps and options for equipment hour allocation. The equipment is fitted with the equipment monitoring hardware communicate operating data and GPS position to the servers of the equipment monitoring system 501. At midnight, the interactive server tool for on-site job optimization calls the equipment monitoring system to fetch operating data for all equipment 502. On the next day, the user opens the interactive mobile tool on the electronic device, selects a job 503 and performs synchronization with the server tool for the data including the equipment hours in previous day 504. The user must enter the progress first for the previous day as shown in 505 (FIG. 3). When one navigates to Equipment Allocation page 506 of the interface for the interactive mobile tool, the left pane displays an equipment listing with quantity of hours (running and idle) for each piece of equipment. The right pane displays “Pay Items and Tasks” for which the user or foreman has entered progress on the Progress page 507. The user selects a piece of equipment in the listing by tapping the checkbox for that piece and the interactive mobile tool determines if any other piece of equipment is already selected 509. If yes, the optimization tool automatically deselects the other piece. Hours allocated for the other piece are cleared from the tasks in the right-hand pane 513. Then, the user proceeds to enter a quantity of time against a task and optionally a freeform comment on the task as well 514. If there is no other equipment already being selected, the user directly proceeds to the step 514. In the following step, the interactive mobile tool validates that the input amount of time is not negative and the time is in hour:minute format 515. If it does not pass the validation, an error message is generated 516 and the user return to step 514. If it passes the validation, the mobile tool updates the total hours for the task, unallocated amount for the selected equipment in the left-hand pane and today's total amount in the footer section of the right-hand pane of the interface 517.

In next step, the user can choose to select another equipment 519, enter more hours for selected equipment 520 or mark allocation for selected equipment as complete 521. When choosing the last option, the user taps the “Mark As Complete” radio button in the footer section of the right-hand pane 522. The interactive mobile tool validates whether the total allocated hours are equal to actual hours for selected equipment 523. If not, an error message is generated 524 and the user returns to step 518. If the validation passes, the optimization tool updates the database to reflect that allocation for selected equipment is complete 525. The user can then select another equipment 527 or unmark allocation for selected equipment as complete 528. By doing the later, the interactive mobile tool sets radio button to “False” 529 and updates database to reflect allocation as not complete 530 and the user returns to step 518.

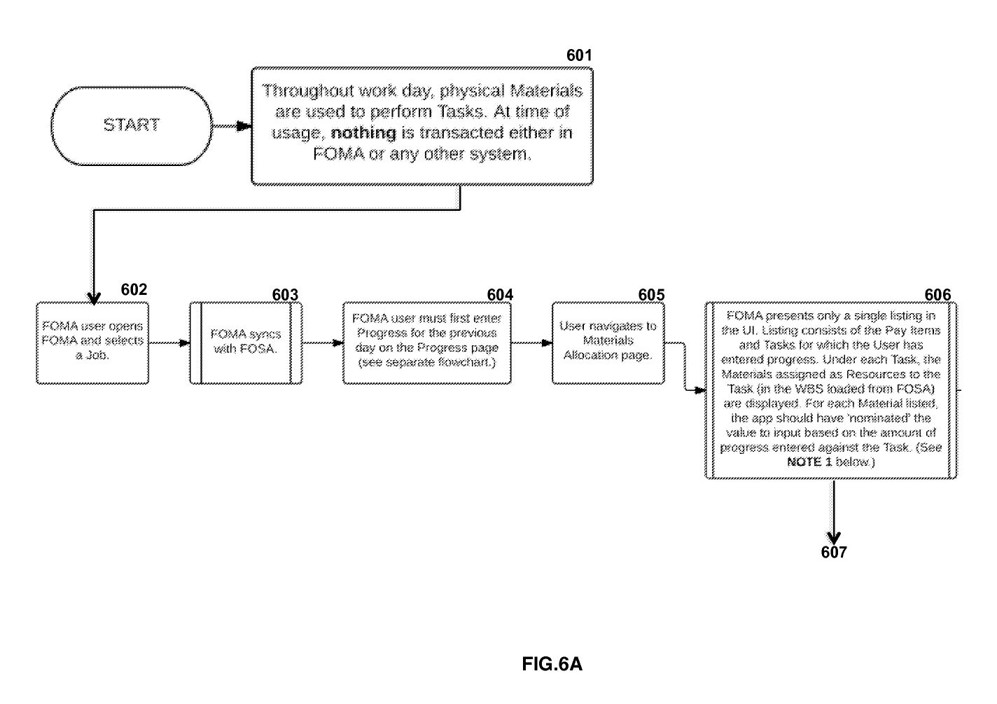

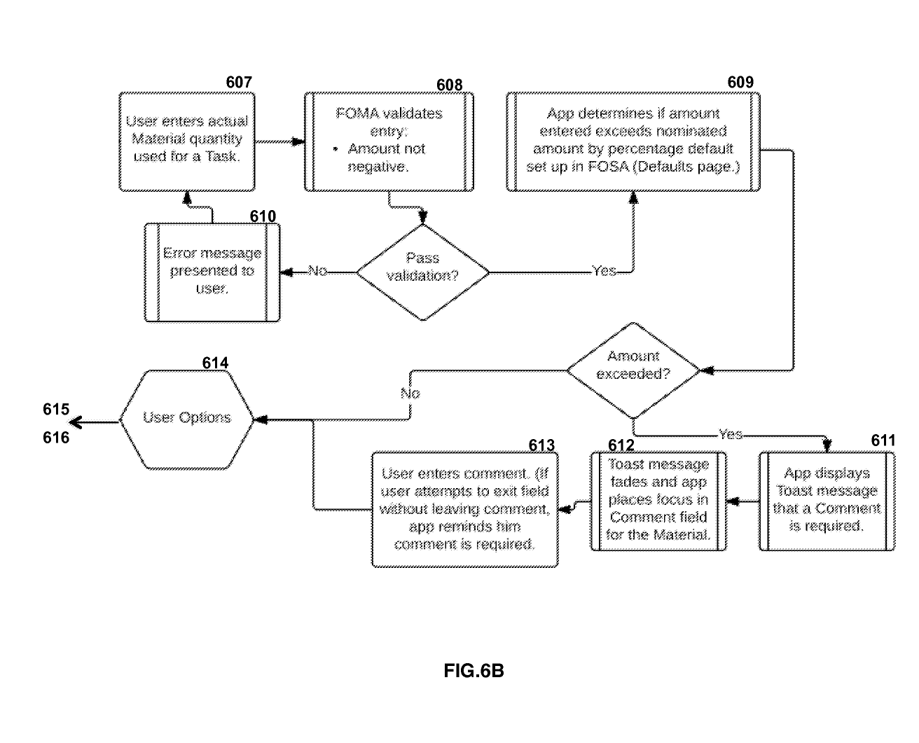

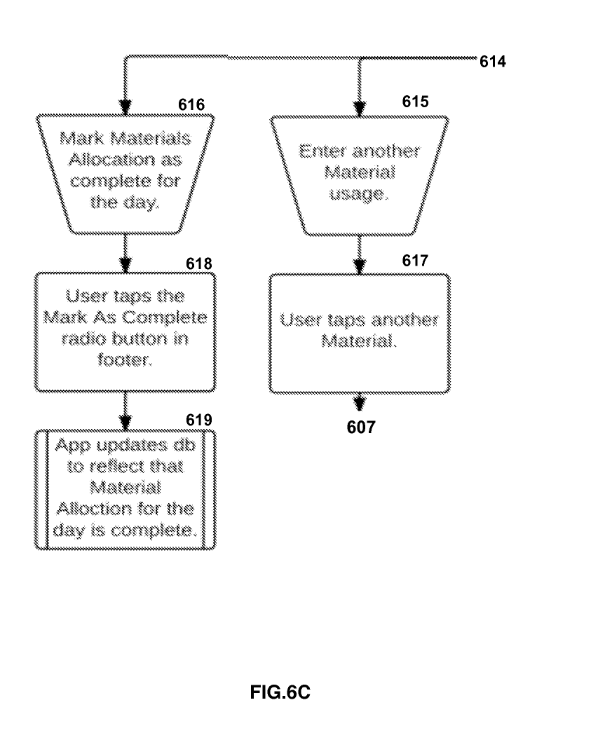

FIGS. 6A-6C are flowcharts of the steps and options for material allocation. Throughout a working day, physical materials are used for jobs or tasks. At time of usage, no information regarding material usage is transacted in the interactive mobile fool for either the server or the electronic device 601. The user starts the mobile tool on the electronic device, selects a job 602 and synchronizes data with the interactive server tool 603. The user must first enter progress for the previous day on the progress page (as shown in FIG. 3) 604. The user navigates to “Material Allocation” page of the interface for the interactive mobile tool 605. The user interface presents only a single listing, consisting of the Pay Items and Task for which the user has entered progress. Under each task, the material assigned as resources to the task (in the work breakdown structures unloaded to the server) are displayed. For each material listed, the interactive mobile tool should suggest the value to input based on the amount of progress entered against the task 606. The user enters actual material quantity used for a task 607. The mobile tool validates the entry by ensuring the amount is not negative 608. If it is negative, an error message is generated 610 and the user returns to step 607. If it is not negative, the mobile tool determines whether the amount entered exceeds the provided amount by percentage default set up in the interactive server tool 609. If it exceeds the amount, the optimization tool generates a toast message that requires a comment 611. The toast message fades and the optimization tool places focus in comment field for the material 612. If the user attempts to exit the field without leaving comment, a reminder is generated for a required comment. The user enters a comment 613 and proceeds to the next step with two options. If the entered amount does not exceed the provided amount, the user directly proceeds to the next step with the same two options 614.

For the first option, the user enters another material usage 615 by tapping another material on the user interface 617, returning to step 607. For the second option, the user marks materials allocation as complete for the day 616 by tapping the “Mark As Complete” radio button footer 618. The optimization tool subsequently updates the database to reflect that “Material Allocation” for the day is complete 619.

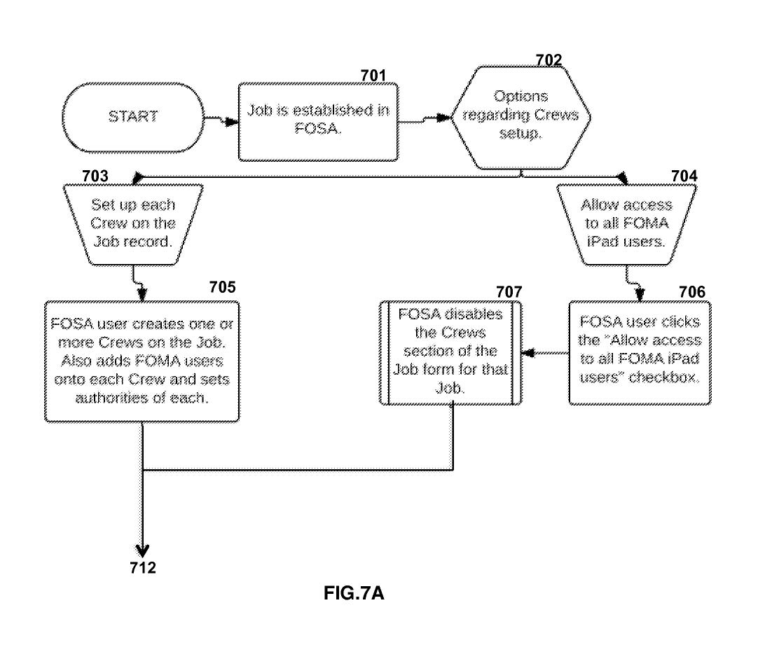

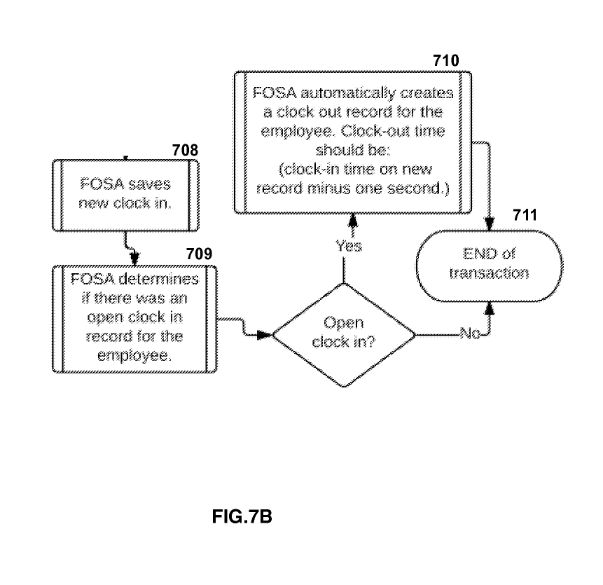

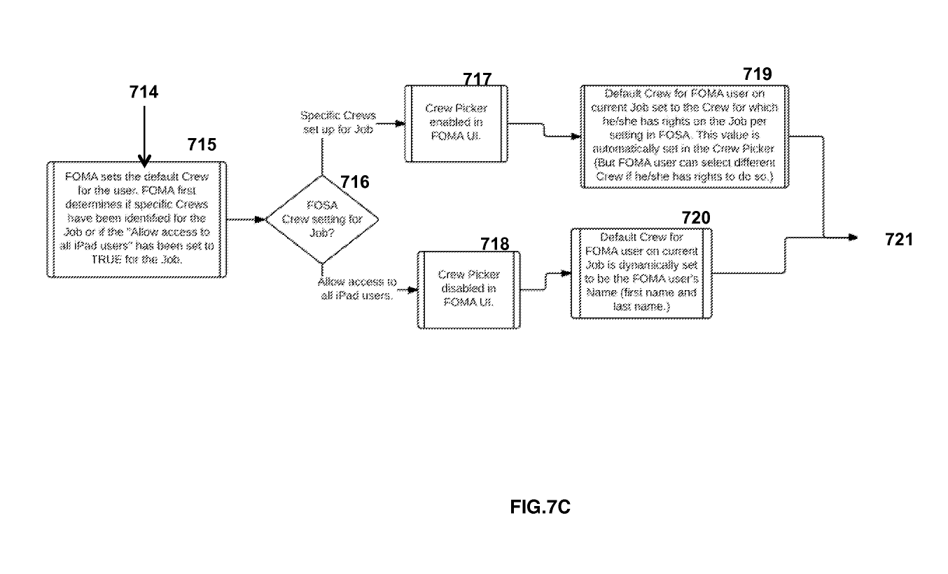

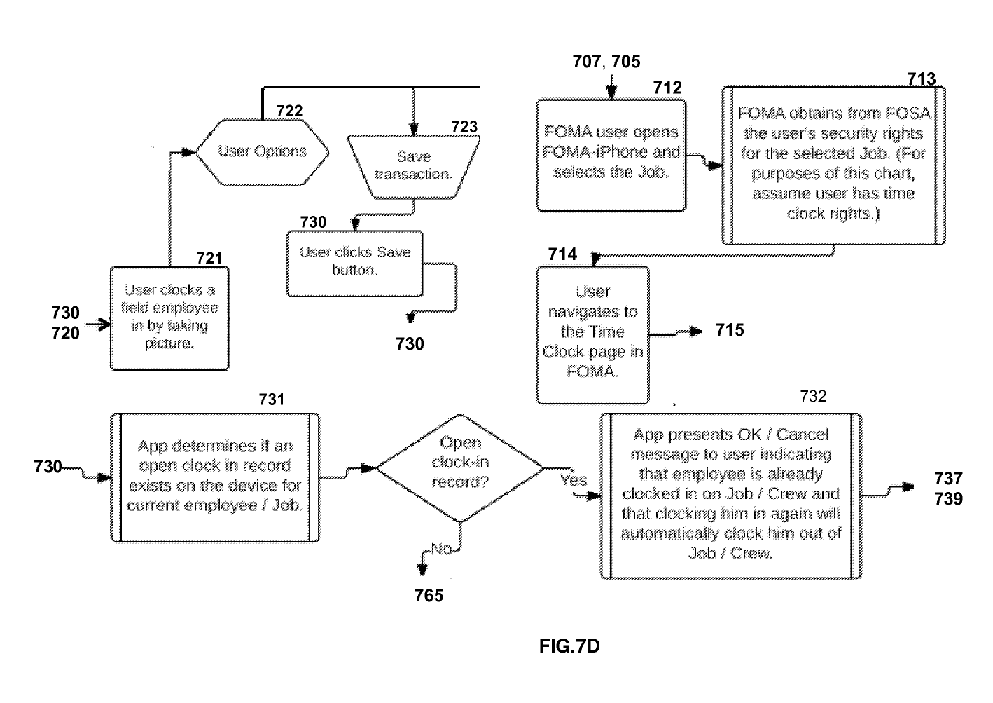

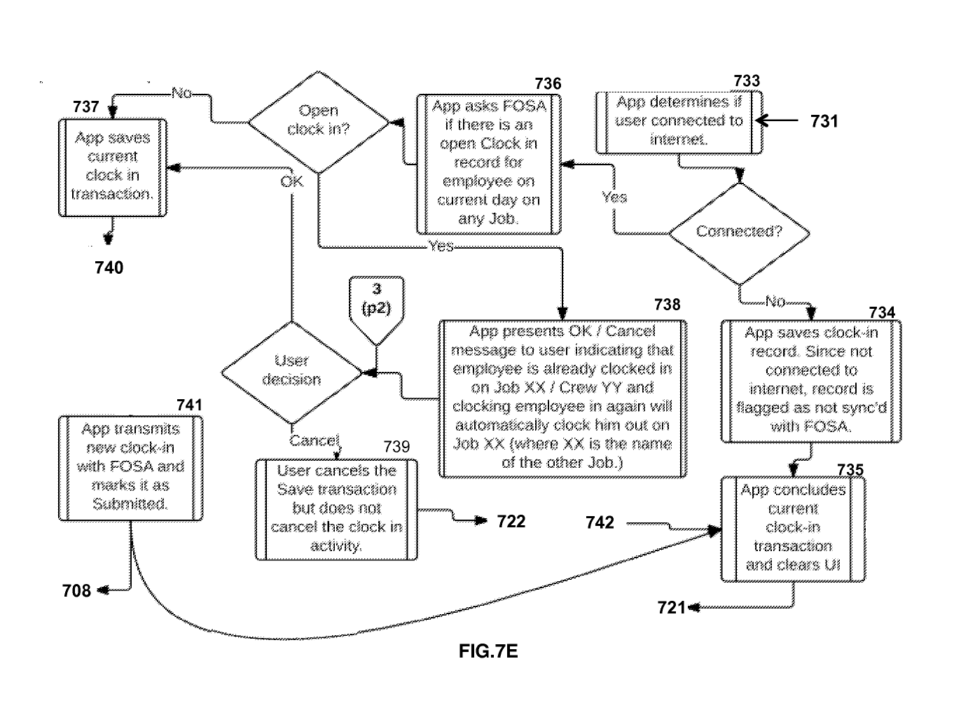

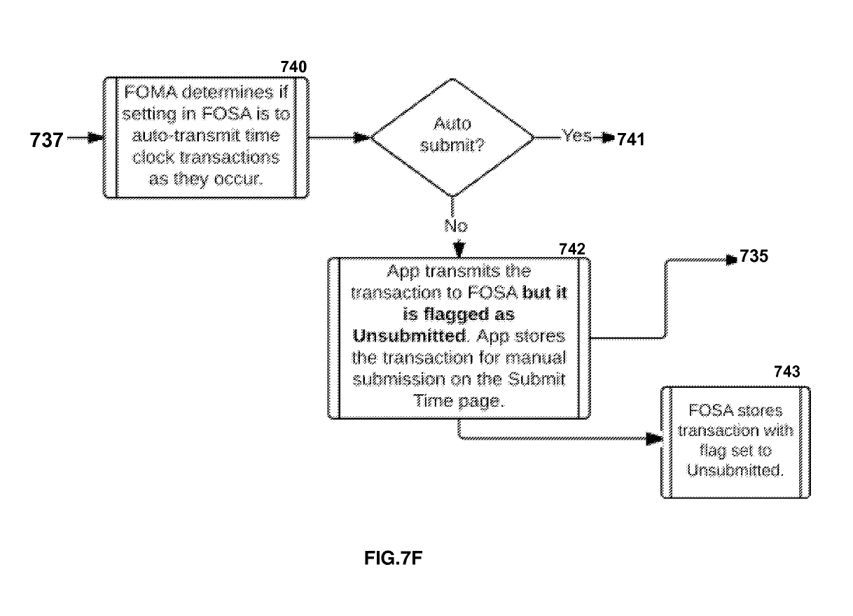

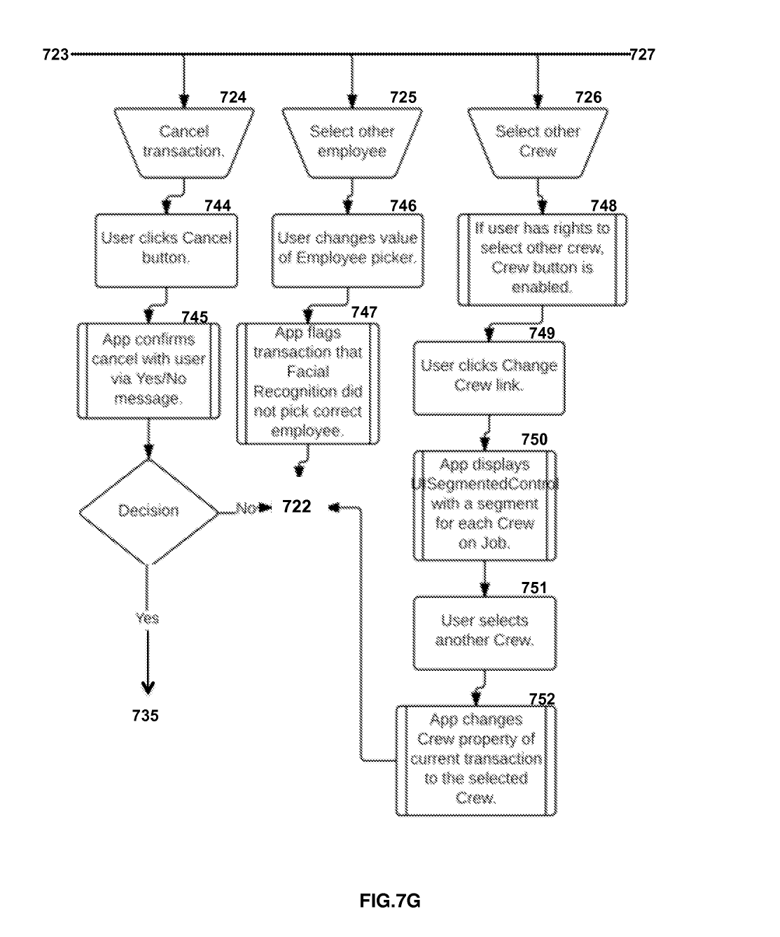

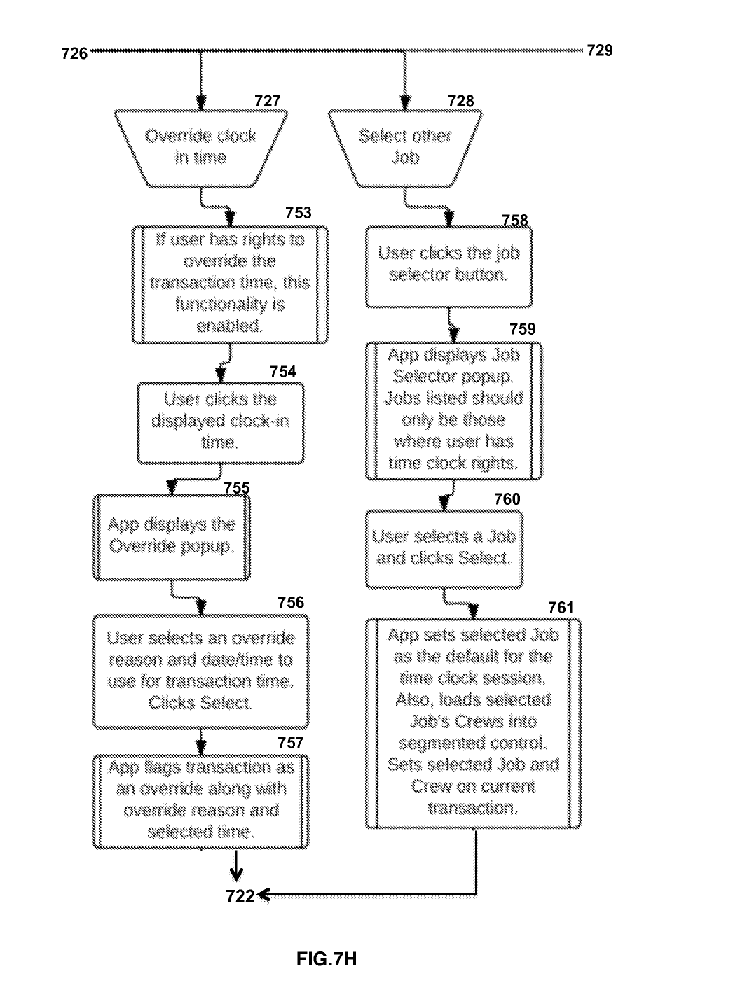

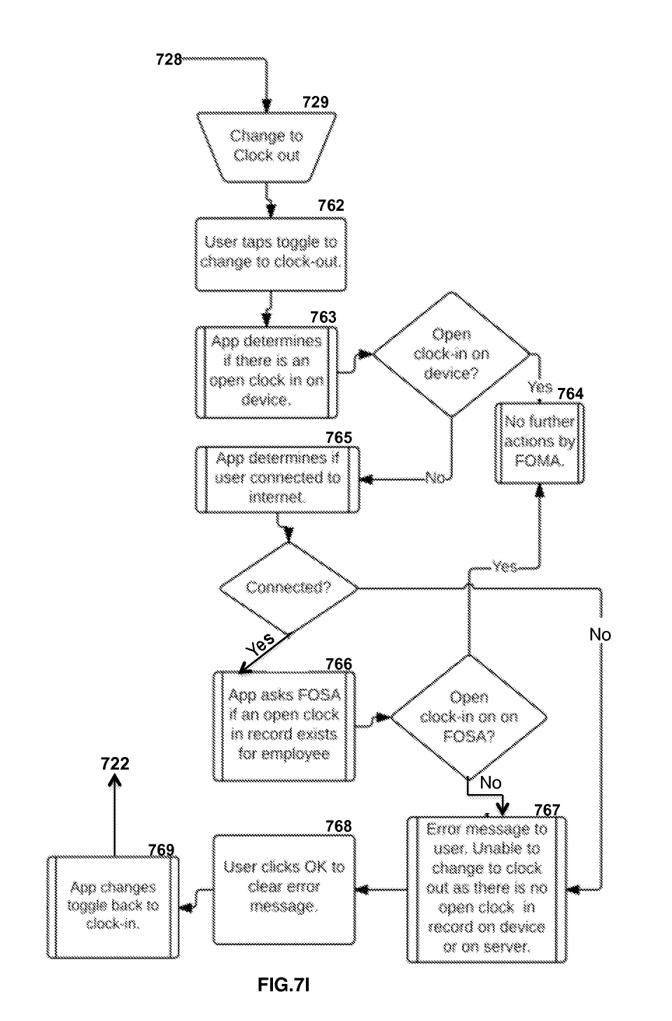

FIGS. 7A-7I are flowcharts of the steps and options for timeclock transactions. When a job is established in the server for the interactive mobile tool for on-site job optimization 701, the administrator of the server has two options to set up the security settings for the user of the mobile tool installed on the electronic devices 702. For the first one, the server administrator allows access of the job information to all users of the electronic devices 704 by clicking the “Allow access to all users” check box 706 and disabling the crews section of the job form for the selected job 707. For the second option, the server administrator sets up each crew on the job record, creates one or more crews on the job and adds the users of electronic device based mobile tool onto each crew and sets authorities for each 705.

After the administrator sets up all the information, the user of the electronic device based mobile tool selects the job 712 (FIG. 7D), obtains the security rights for the selected job from the server 713 and navigates to the “Time Clock” page in the interface of the optimization tool 714 and proceed to 715 (FIG. 7C). The interactive mobile tool sets the default crew for the user. The mobile tool first determines whether specific crews have been identified for the job or the “Allow access to all users” has been set to “True” for the job 715. If the setting is for specific crews set up for job, the “Crew Picker” is enabled to authorize the default crew set by the server administrator for the access to the job information 718. The value is automatically set in the “Crew Picker” (but the interactive mobile tool user can select different crew if he or she has right to do so) 719. If the job is configured to “Allow access to all users”, the Crew Picker is disabled in the interface of the optimization tool 718. The default Crew for the user of the optimization tool on present job is dynamically set to be the user's name 720. For either of the settings, the user then proceeds to the next step to clock a field employee in by taking picture 721. The user generally has seven options at this point 722.

For the first option 723 as shown in FIG. 7D, the user clicks “Save” button on the interface of the interactive mobile tool 730 and the interactive mobile tool determines if an open clock in record already exists on the device for current employee or job 731. If it does not exist (FIG. 7E), the mobile tool determines whether the user is connected to the Internet 733. With no Internet connection, the optimization tool saves clock-in record, which is flagged as not synchronized with the server 734. The mobile tool further concludes the current clock-in transaction and clears the user interface 735 and the user returns to step 721. With Internet connection available, the interactive mobile tool inquires the server whether there is an open clock in record for the employee on current day on any job 736. If not, the mobile tool saves current clock in transaction 737 and proceeds to step 740 in FIG. 7F.

If there is an existing open clock in record for the employee, the interface of the mobile tool presents OK/Cancel message to the user indicating that employee is already clocked in on job/crew and clocking employee in again will automatically clock him out from the job he is currently in 738. The user can select to cancel the save transaction with the clock still active 739, and the user returns to step 722 in FIG. 7D, or to save the current clock in transaction 737 which will automatically clock the him out of the prior job and then record the new clock-in transaction before proceeding to step 740 in FIG. 7F. In the next step (740 in FIG. 7F), the interactive mobile tool determines whether the setting in the server tool indicates to auto-transmit time clock transactions as they occur 740. If not, the optimization tool transmits the transaction to the server and flags it as “un-submitted” 742. The transaction is then stored in the optimization tool for manual submission on the “Submit Time” page 742. The interactive mobile tool concludes current clock-in transaction and clears the user interface 735 (FIG. 7E), and the user returns to step 721 in FIG. 7D. If it is set as automatic, the mobile tool transmits new clock-in to the server and marks it as “submitted” 741. The interactive server tool then saves the new clock in 708 (FIG. 7A) and determines whether there was an open clock in record for the employee 709. With no existing open record, it is the end of transaction 711. With existing clock in record open, the interactive server tool automatically creates a clock out record for the employee and sets the clock-out time as one second ahead of the clock-in time, ending this transaction 710.

For the second option as shown in FIG. 7G, the user can click “Cancel” button 744 (FIG. 7G) to cancel the transaction 724. The interface of the interactive mobile tool then presents the “Yes/No” message to ask the user for confirmation 745. If the answer is no, the user goes back to step 722 in FIG. 7D. If the user chooses yes, the mobile tool concludes the current clock-in transaction and clears the user interface 735 in FIG. 7D. The user returns to step 721 in FIG. 7D.

For the third option shown in FIG. 7G, the user can select another employee 725 by changing value of employee picker 746. The optimization tool flags the transaction that Facial Recognition did not pick correct employee for 747 and return to 722 in FIG. 7D.

For the fourth option shown in FIG. 7G, the user can select other crew 726 by clicks “Change Crew” link if authorized by the server administrator 748, 749. The interface of the interactive mobile tool displays user interface segmented control with a segment for each crew on the job 750. The user selects another crew 751. The mobile tool changes crew property of current transaction to the selected crew 752 and return to the step 722 in FIG. 7D.

For the fifth option as shown in FIG. 7H, the user can override the clock in time 727 if authorized to do so 753. The authorized user clicks the displayed clock-in time 754. An override popup is displayed in the interface of the mobile tool 755. The user selects an override reason and date/time to use for transaction time and clicks “Select” 756. The interactive mobile tool flags the transaction as an override along with override reason and selected time 757 and return to the step 722 in FIG. 7C.

For the sixth option shown in FIG. 7H, the user can select another job 728 by clicking the job selector button 758. A Job Selector popup shows up in the interface. The job listed here should only be those, for which the user has the right for timeclock 759. The user selects a job and clicks “Select” 760. The interactive mobile tool sets selected job as the default for the time clock session, loads the crews for selected job in to the segmented control and sets elected job and crew on current transaction 761, returning to the step 722 in FIG. 7D.

For the seventh option shown in FIG. 7I, the user can choose to clock out 729 by tapping the toggle 762. The interactive mobile tool determines whether there is an open clock in on the device 763. If there is, no further action is conducted 764. If there is no open clock in, the mobile tool further determines whether the device is connected to the Internet 765. With the Internet connection, the optimization tool inquires the server whether an open clock in record exists for employee in the server 766. If there is, no further action is conducted 764. If there is no open clock in record, the optimization tool generate an error message indicating it is unable to change to clock out since there is no open clock in record on the device or on the server 767. The user clicks “OK” button to clear error message 768. The mobile tool changes toggle back to clock in 769, returning to the step 722 in FIG. 7D. If there is no Internet connection, the mobile tool directly generates an error message indicating it is unable to change to clock out since there is no open clock in record on the device or in the server 767. The user clicks “OK” button 768. The mobile tool changes toggle back to clock in 769, returning to the step 722 in FIG. 7D.

FIG. 8 is the flowchart of the steps for the timeclock processing on the server. When an internet connection is available, the timeclock transactions from the interactive mobile tool on the electronic device are transmitted to the server while the user saves each transaction on the electronic device 801. The interactive server tool for on-site job optimization persists these transactions as un-submitted 802. The user of the mobile tool on the electronic device submits timeclock transactions from the “Submit Time” page on the device 803. For each transaction, if it had already been transmitted to the server, it is then marked as submitted. New transactions are persisted and then marked as submitted 804.

The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention.

What is claimed is:

1. A system for optimizing on-site job execution and management for a company, comprising:
a bid management system;
an electronic mobile device having at least a processor, a memory and a display coupled to the processor;
at least one network connection;
an equipment monitoring system;
an interactive mobile tool for on-site job optimization coupled to the electronic device;
an enterprise resource planning system;
a project planning system;
a document imaging system;
an external weather module interfaced with said interactive mobile tool;
a server machine having at least a processor, a memory and a display coupled to the processor; and
an interactive server tool for on-site job optimization coupled to the server and communicably connected to said bid management system, equipment monitoring system, said interactive on-site job optimization mobile tool, said enterprise resource planning system, said project planning system, said document imaging system and said via said network connection.

2. The system of claim 1, wherein said interactive mobile tool for on-site job optimization comprises:
a user interface comprising a plurality of activatable widgets, toggles, and input windows;
a plurality of databases accessible by the interactive server tool and said activatable widgets, toggle, input windows.
a displayable interactive base map coupled to the databases, the activatable widgets, toggles and input window.
a weather application coupled with the map.

3. The system of claim 2, wherein the widgets, toggles and input windows are configured to query and/or modify the databases containing the data related to user-selected project or job.

4. The system of claim 2, wherein the database comprises data related to job status, job location, weather on the job-site, employees assigned to the job, equipment assigned to the job, material usage for the job, labor hours, equipment hours, user comments and daily reports for the job.

5. The system of claim 2, wherein the displayable interactive base map displays the job locations and geographic fence for each job.

6. The system of claim 2, wherein the weather tool is configured to display the weather information and forecast on a job site.

7. The system of claim 1, wherein the interactive mobile tool is configured to:
receive the data and information related to one or more jobs from the interactive server tool;
store and categorize these data and information in the electronic mobile device;
receive the user's input and changes on the data and information via the interface of the interactive mobile tool;
update the data and information related to one or more jobs in the database according to user's input and changes;
transmit the updated data information to the interactive server tool; and
generate and submit daily report for said one or more jobs to the interactive server tool.

8. The system of claim 1, wherein the interactive server tool is configured to:
receive the initial data and information related to said one or more jobs;
store and categorize these data and information in said databases;
authorize the security limits for each interactive mobile tools to access and modify the data and information related to said one or more jobs;
transmit the initial and updated data and information related to said one or more jobs to the interactive mobile tool installed on said electronic mobile device; and
receive updated data and information related to said one or more jobs from interactive mobile tool and update said databases.

9. The system of claim 8, wherein the interactive server tool further comprises a mid-ware configured to interface said server tool with multiple types of enterprise resource planning systems, job bidding systems, equipment monitoring systems, and external web-based weather applications to supply required data to the system of claim 2 and provide updates to multiple types of enterprise resource planning systems.

10. The system of claim 8, wherein said initial data and information of said one or more jobs is obtained from the bidding system, the enterprise resource planning system, and the equipment monitoring system.

11. A user-implemented method for optimization of on-site job management, comprising the steps of:
loading the initial data and information related to one or more jobs to the interactive server tool of claim 1;
setting up the security limits and access rights for the interactive mobile tools via the interactive server tool;
synchronizing all the data and information related to one or more jobs to one or more authorized interactive mobile tool;
clocking field employees in and out of job throughout the day using the interactive mobile tool;
submitting the timeclock transactions to the interactive server tool;
monitoring the equipment information on the job via the equipment monitoring system throughout the day;
synchronizing all the updated data and information related to said one or more jobs from previous day;
entering the progress for previous day via the interface of the interactive mobile tool;
allocating labor hours, equipment hours, material usage, job cost to tasks;
submitting daily report and transmitting the updated data to the interactive server tool from the interactive mobile tool; and
generating import files for updates to the enterprise resource planning system and payroll system.

12. The method of claim 11, wherein the initial data and information loaded to the interactive server tool is extracted from the enterprise resource planning system, equipment monitoring system and job bidding system.

13. The method of claim 12, wherein said initial data and information extracted from the enterprise resource planning comprises job work breakdown structure, and personnel information of the selected one or more jobs.

14. The method of claim 12, wherein said initial data and information extracted from the job bidding system comprises the estimated cost for each task in the job work breakdown structure and total project cost of the selected one or more jobs.

15. The method of claim 12, wherein said initial data and information extracted from the equipment monitoring system comprises geographic fences, equipment locations, equipment photos, idle hours for each equipment and maintenance information for each equipment.

16. The method of claim 13, wherein said personnel information comprises image of each employee, total hours worked for each employee, unallocated work hours for each employee, and crews containing a group of employees.

17. The method of claim 12, wherein said security limits and access rights for the interactive mobile tools comprises permission for time overrides, accessibility to selected jobs, accessibility to crew section of the personnel information, and permission to create and change a crew for a job.

18. The method of claim 11, wherein the employees are clocked in and out of the job using facial recognition technology to authenticate the information of said employees.

19. The method of claim 11, wherein allocating labor hours to the tasks comprises the steps of:
synchronizing the data of labor hours from the interactive server tool to the interactive mobile tool;
inquiring the worked hours and unallocated hours for each employee or crew along with the image of each employee via the interactive mobile tool;
assigning the employee or crew with unallocated hours to a task;
validating all the hours are allocated; and
submitting the allocation of labor hours to the interactive server tool.

20. The method of claim 11, wherein allocating equipment hours to the tasks comprises the steps of:
synchronizing the data for equipment from the interactive server tool to the interactive mobile tool;
inquiring the information of a piece of equipment including the location of the equipment, pictures of the equipment, worked and idle hours, and maintenance information of the equipment via the interactive mobile tool;
assigning the equipment with unallocated hours to a task based on said information; and
submitting the allocation of equipment hours to the interactive server tool.

21. The method of claim 11, wherein allocating material to the tasks comprises the steps of:
synchronizing the data for material usage from the interactive server tool to the interactive mobile tool;
inquiring the information of material usage against tasks including image of each material, and nominated usage for each material based on progress entered against the tasks;
entering the actual usage of said material in the interface of the interactive mobile tool;
adding comments based on the difference between nominated material usage and the entered actual usage; and
submitting the allocation of equipment hours to the interactive server tool.
